(19) United States
(12) Patent Application Publication
(10) Pub. No.: US 2025/0286737 A1
(43) Pub. Date: Sep. 11, 2025

(54) APPARATUS FOR GENERATING A PLURALITY OF REVOCATION DATA SHARDS

(71) Applicant: Intel Corporation, Santa Clara, CA (US)

(72) Inventors: Mateusz BRONK, Gdansk (PL); Dan HOROVITZ, Rishon Lezion (IL)

(21) Appl. No.: 19/220,146

(22) Filed: May 28, 2025

(51) Int. Cl. H04L 9/32; H04L 9/08

(52) U.S. Cl. CPC H04L 9/3268; H04L 9/0825; H04L 9/3247

(57) ABSTRACT

It is provided an apparatus comprising interface circuitry, machine-readable instructions, and processing circuitry to execute the machine-readable instructions. The machine-readable instructions include instructions to issue a certificate, wherein the certificate is configured to authenticate an identity of a requester to a verifier. The machine-readable instructions further include instructions to obtain revocation data comprising identifiers of previously issued certificates that have been revoked. The machine-readable instructions further include instructions to generate a plurality of revocation data shards based on the revocation data, each revocation data shard covering a respective issuance time range and comprising identifiers of revoked certificates issued within that respective time range. The machine-readable instructions further include instructions to provide the plurality of revocation data shards to a broker configured to perform communication between the requester and the verifier.

### BACKGROUND

In the field of cryptographic authentication, digital certificates may be used to associate public keys with the identities of entities, enabling secure communication and trust establishment. Certificate authorities may issue certificates and may also maintain certificate revocation mechanisms to ensure that compromised or invalid certificates can be detected and rejected. Verification of certificates, including the assessment of revocation status, is an important aspect of secure communications, particularly in systems where real-time access to revocation information may be limited or resource constraints exist on the verifying entities.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a block diagram of an example of an apparatus;

FIG. 3 illustrates a block diagram of an example of an apparatus;

FIG. 4 illustrates an example of a system;

FIG. 5 illustrates a flowchart of an example of a method;

FIG. 6 illustrates an example of system comprising a certificate authority, a prover, a broker and a verifier;

FIG. 7 illustrates an example process for an end-to-end authentication and revocation verification flow between a prover, a broker, and a verifier, supported by a certificate authority;

FIG. 8 illustrates an example process for the issuance of revocation data shards by a certificate authority;

FIG. 9 illustrates an example process for generating and issuing a revocation data shards;

FIG. 10 illustrates an example process for verifying a certificate using a revocation data shard at a verifier device; and

FIG. 11 illustrates an example of a broker operation process comprising an online phase and an offline phase

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

For example, Public Key Infrastructure (PKI) systems and hierarchical trust models may be based on certificate authorities which are widely utilized for establishing end-to-end trust between communicating entities. For example, this may be associated with web-based use cases, PKI standards such as X.509 [RFC 5280] are adopted at the system-on-chip (SoC) level, supporting secure exchanges between cloud platforms and hardware components, as well as chip-to-chip communication scenarios. Examples include mutual attestation protocols such as the Security Protocol and Data Model (SPDM). For example, PKI architectures may facilitate dynamic trust expansion. That is even with a fixed trust anchor, new participants can be incorporated into the ecosystem through certificate issuance by an existing certificate authority. This flexibility may be desirable for embedded devices with extended operational lifetimes, including deployments in offline or industrial environments. To maintain trustworthiness in such ecosystems, certificate revocation mechanisms, such as the issuance of Certificate Revocation Lists (CRLs) by the certificate authority, are typically employed to remove compromised or outdated certificates.

In some PKI deployment, a verifier validating a certificate may be generally assumed to possess access to comprehensive revocation data, either through full CRL retrieval or real-time query mechanisms such as the Online Certificate Status Protocol (OCSP), and to maintain a trusted time source for verifying certificate validity periods and the freshness of revocation information. However, these assumptions might not hold in embedded device environments, such as Internet of Things (IoT) or firmware-based systems. Such devices may still require certificate and revocation validation but typically lack a trusted real-time clock due to hardware complexity and cost considerations. Consequently, long-lived certificates combined with replay-protected non-volatile storage mechanisms may be employed, enabling basic anti-replay protections for revocation data. Nevertheless, this approach may introduce challenges associated with the accumulation of revocation data over time: without the ability to safely discard expired entries, the size of the CRL dataset may grow, eventually exceeding the processing and memory capabilities of resource-constrained embedded devices, which are typically designed to handle data flows in tens of bytes rather than megabytes.

The present disclosure relates to an architecture for enabling certificate revocation validation in resource-constrained environments by partitioning the certificate revocation logic between two entities, a broker and a verifier, and employing ahead-of-time revocation data sharding techniques. In some examples, the revocation list may be pre-partitioned into a plurality of fixed-maximum-size revocation data shards. Each revocation data shard may be generated based on grouping criteria that dynamically evolve with each issuance of revocation data, such as the issuance time of the certificates. In some examples, the sharding may be performed ahead-of-time by a certificate authority, while in alternative embodiments it may be performed just-in-time by a delegated revocation authority accessible over a network. The broker may be configured to store or cache the complete shard group associated with the revocation data and to select the appropriate shard based on parameters derived from the certificate. The broker may act as a regular computing entity, such as a software module executing in a general-purpose environment, and may reside outside the trust boundary of the verifier. In the verification flow, the prover, assisted by the broker, may provide both its certificate and the relevant revocation data shard to the verifier. The verifier may then validate the certificate using only the received shard, without requiring knowledge of the complete revocation list or additional shards. If the shard does not cover the issuance time of the certificate or if the certificate is listed as revoked within the shard, the verifier may reject the certificate accordingly.

The use of the certificate's issuance timestamp as a grouping criterion for shard generation enables addressing the grow-only nature of revocation datasets even in systems lacking a trusted time source. For example, by ceasing the issuance of obsolete “tail” shards, the certificate authority may allow the verifier to operate correctly without trusted clock infrastructure. The proposed technique provides several advantages. Pre-shared, pre-partitioned revocation data (such as CRLs) may simplify maintenance and allow efficient distribution of critical revocation information to target devices without transmitting the full set of revoked certificates. Embedded and constrained verifiers may thus validate certificates using lightweight operations without requiring access to online status responders or full CRLs, enabling revocation validation in air-gapped, offline, or bandwidth-limited environments. Furthermore, fixed-size sharding may simplify verifier-side logic and facilitate IP block integration into highly power- and security-optimized hardware.

The present disclosure may address challenges encountered in real-world scenarios, such as the integration of PKI certificate verification into hardware blocks, such as a security or startup-oriented intellectual property (IP) block of modern Central Processing Units (CPUs), dedicated embedded security controllers and the like. In particular, the solution enables revocation-aware authentication in environments where access to secure real-time clocks is infeasible, where stringent power and performance requirements apply, and where offline operation must be supported. This approach may generalize to a wide range of embedded devices where power efficiency, verifiable simplicity, and long-term secure operation are critical design principles.

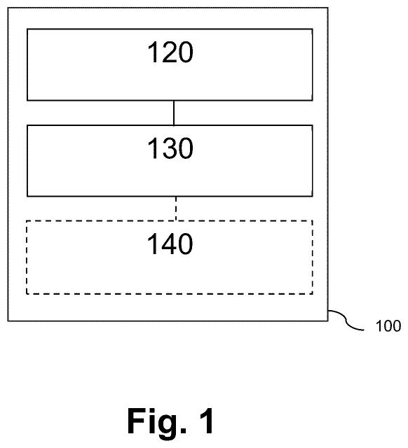

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, apparatus 100 may be a certificate authority configured to issue digital certificates and generate revocation data for use in cryptographic identity verification systems. The certificate authority may serve as a trusted entity within a public key infrastructure and may be responsible for generating and digitally signing certificates that bind public keys to the identities of requesters.

The processing circuitry 130 is configured to issue a certificate. The certificate is configured to authenticate an identity of a requester to a verifier. For example, a certificate may be a cryptographically signed data structure that binds identity information to a corresponding public key, thereby enabling a requester to prove its identity to a verifier in a secure, verifiable manner. A certificate may serve as a digital assertion made by the certificate authority that a particular public key belongs to a specific requester identity, and may include a set of fields such as subject identifiers, the associated public key, validity period parameters, and issuer information. A certificate may be structured according to a standardized format, such as the X.509 format, which is commonly used in public key infrastructures.

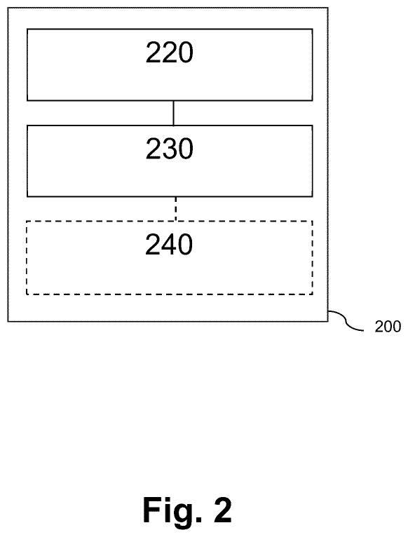

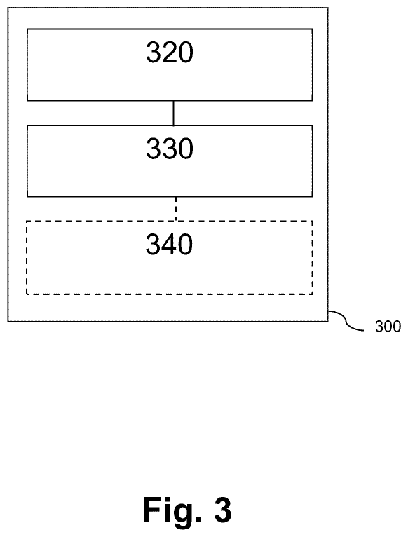

For example, a requester may be an entity (for example, apparatus 200, se FIG. 2) that seeks to obtain the certificate from the certificate authority (for example apparatus 100) in order to authenticate its identity to another entity referred to as a verifier (for example, apparatus 300, see FIG. 3). A requester may be any device, module, software agent, or system component capable of generating or holding a cryptographic key pair and initiating a certificate signing request. A requester may be configured to transmit identity information and a corresponding public key (or a proof of possession of the corresponding public key, for example encapsulated in a Certificate Signing Request) to a certificate authority and to receive in response a digitally signed certificate that binds the public key to the requester's asserted identity.

In some examples, the verifier (for example, apparatus 300, see FIG. 3) may be an entity configured to evaluate the authenticity of the certificate presented by the requester, and to establish trust in the identity of the requester based on the result of that evaluation. The verifier may perform one or more cryptographic validation operations, such as verifying the digital signature applied by the certificate authority, checking the certificate's issuance and expiration dates, and performing revocation checks using revocation data or revocation data shards. The verifier may be implemented in a resource-constrained environment such as an embedded device or secure execution module, and may operate without access to a complete certificate revocation list or a real-time clock. The requester and the verifier may interact within a cryptographic authentication protocol in which the requester presents the certificate to the verifier to prove its identity. The certificate may serve as a trust anchor that allows the verifier to establish a secure session or grant access to protected resources. For example, a hardware device may act as a requester and present its certificate to a verifier embedded in a host platform. The verifier may then validate the certificate and confirm the authenticity of the device prior to initiating secure communication.

In some examples, issuing a certificate may comprise generating and signing the certificate using a private key held by the certificate authority. The act of issuance may include receiving a certificate signing request from the requester, wherein the certificate signing request comprises a cryptographic public key and identity information. The certificate authority may then assemble the certificate contents using this data, embed additional metadata or policy extensions if needed, and produce a digital signature over the assembled certificate using its private key. The resulting signed certificate may then be transmitted back to the requester for use in cryptographic authentication protocols. For example, the requester may generate its own key pair and transmit a certificate signing request to the apparatus 100. The certificate signing request may include the public key of the requester and a subject identifier such as a device serial number. The processing circuitry 130 may then issue the certificate by digitally signing a data structure that incorporates the public key and identity information. The resulting certificate may later be presented by the requester to a verifier to allow the verifier to confirm the device's identity. In some examples, the processing circuitry 130 is further configured to transmit the generated certificate to the requester.

The processing circuitry 130 is further configured to obtain revocation data comprising identifiers of previously issued certificates that have been revoked. For example, the revocation data may be a collection of machine-readable entries that represent certificates which were previously issued by the certificate authority and have subsequently been marked as invalid prior to their expiration. The revocation data may serve as a basis for verifying the continued validity of certificates by allowing verifiers to detect and reject certificates that were revoked due to compromise, misissuance, or operational policy changes. The revocation data may comprise structured records that identify each revoked certificate by the corresponding identifier and may optionally include associated metadata such as revocation timestamps or revocation reasons.

In some examples, the processing circuitry 130 may be configured to obtain revocation data as part of a scheduled or event-driven process. For example, the revocation data may be obtained by the processing circuitry 130 from the storage circuitry 140. In some examples, the revocation data may be obtained from an external source, for example via the interface circuitry 120. In this context, the interface circuitry 120 may be configured to access a revocation distribution service, a remote certificate database, or a cryptographic management server from which the revocation data is received in full or in incremental updates.

The revocation data may comprise identifiers of previously issued certificates that have been revoked, wherein each identifier may uniquely refer to a revoked certificate that was originally issued by the certificate authority. The identifier of a revoked certificate may, for example, be a certificate serial number, a hash value of the certificate contents, or a fingerprint derived from the certificate's public key or subject name. These identifiers may be sufficient to enable a verifier or intermediary to determine whether a given certificate has been revoked. For example, a certificate authority may maintain a list of revoked certificate serial numbers and publish this list as part of a certificate revocation list (CRL), or may embed subsets of these identifiers in revocation data shards intended for downstream use in constrained verification environments.

The processing circuitry 130 is further configured to generate a plurality of revocation data shards based on the revocation data. Each revocation data shard covering a respective issuance time range and comprising identifiers of revoked certificates issued within that respective time range. For example, a revocation data shard may be a discrete portion of revocation data comprising a selected subset of identifiers of revoked certificates. In some examples, a revocation data shard may be a partition of the revocation data that contains only those identifiers of revoked certificates sharing a predetermined grouping criterion

In some examples, the grouping criterion may be the issuance time. That is, in some examples, a revocation data shard may be a partition of the revocation data that contains only those identifiers of revoked certificates issued within a defined issuance time range. The revocation data shards may enable the verifier to validate certificate revocation status without processing the entirety of the revocation data, by containing only the revoked certificate identifiers that fall within a specific issuance time window.

In some examples, the revocation data shard may comprise a structured data segment that includes a collection of identifiers corresponding to revoked certificates, together with metadata, for example metadata indicating the time range of certificate issuance to which the identifiers apply. For example, the issuance time range may define the boundaries of the shard, such that the shard includes only those identifiers that correspond to certificates originally issued by the certificate authority within that range.

In some examples, the processing circuitry 130 may be further configured to sort the revocation data based on issuance time prior to generating the revocation data shards. The processing circuitry 130 may determine the issuance time for each revoked certificate by parsing metadata fields associated with each certificate identifier, such as the NotBefore field in an X.509 certificate. Once sorted, the processing circuitry 130 may divide the revocation data into multiple groups, each group containing certificate identifiers with issuance times falling within a respective, non-overlapping time range. The size of each shard, that is the number and width of these time ranges may be fixed or dynamically determined based on policy settings, maximum shard size thresholds, or the statistical distribution of the certificate issuance dates. Each group of identifiers may then be formatted into a corresponding revocation data shard, and associated with metadata indicating the covered issuance time range. For example, the processing circuitry 130 may generate one revocation data shard for certificates issued between January 1 and June 30, and another for certificates issued between July 1 and December 31.

In some examples, the processing circuitry 130 may be further configured to include the respective issuance time range into each revocation data shard as an extension of the X.509 format. For example, by including the respective issuance time range into each revocation data shard as an extension of the X.509 format, mechanisms may be used that are structurally compatible with existing revocation formats such as X.509 certificate revocation lists (CRLs). The issuance time range may describe the window of certificate issuance dates for which the identifiers in the revocation data shard are valid, and this range may be added as a structured field or in some examples as a critical extension within the shard format to ensure that downstream components can interpret the scope of the shard. In some examples, the processing circuitry 130 may encode the issuance time range as an X.509 extension field appended to each revocation data shard. The extension may be marked as critical to ensure that verifiers that do not recognize the extension reject the shard, thereby avoiding the risk of incorrect interpretation. This may allow each shard to carry explicit metadata describing its applicable scope without modifying the core CRL semantics.

In some examples, a revocation data shard may be a partition of the revocation data that contains only those identifiers of revoked certificates that share a grouping criterion, such as a specific number of leading digits of a certificate fingerprint, a prefix of a certificate serial number, or a substring or hash-derived pattern of the certificate's subject field. These grouping criterions may define the boundaries of the shard, such that each revocation data shard includes only those identifiers that match the corresponding grouping constraint.

Accordingly, in some examples, the processing circuitry 130 may be further configured to sort the revocation data based on a grouping criterion such as a specific number of leading digits of a certificate fingerprint, a prefix of a certificate serial number, or a substring or hash-derived pattern of the certificate's subject field prior to generating the revocation data shards. The processing circuitry 130 may determine a grouping value for each revoked certificate by extracting or computing a property associated with the certificate identifier, such as a number of leading digits of the certificate's fingerprint or serial number, or a substring or hash-based bucket derived from the certificate's subject field. Once grouped, the processing circuitry 130 may divide the revocation data into multiple sets, each set containing certificate identifiers that match a respective grouping value. The grouping scheme may be defined by policy or derived dynamically based on the distribution of revoked certificates and verifier capabilities. Each group of identifiers may then be formatted into a corresponding revocation data shard, and associated with metadata indicating the applied grouping criterion. For example, the processing circuitry 130 may generate one revocation data shard for certificates whose fingerprint begins with ‘A1’, and another shard within the same shard group for certificates whose fingerprint begins with ‘A2’, ‘A3’, and so forth. In some examples, a different shard group may use a grouping criterion based on the subject Common Name, such as generating one shard for certificates whose subject Common Name hash ends in ‘3F’, and another for certificates whose hash ends in ‘41’. Each shard group may consistently apply a single grouping criterion to ensure non-overlapping shard boundaries and facilitate deterministic shard selection. In some examples, the use of mixed grouping criteria within a single shard group may also be supported.

Coming back to the metadata of a revocation data shard. In some examples, each revocation data shard may comprise metadata shared across the plurality of revocation data shards. For example, metadata of a revocation data shard may comprise auxiliary information embedded within the shard that provides context about the origin, structure, and/or issuance state of the revocation data. The metadata may be common to all shards derived from the same revocation data set and may be used to facilitate shard identification, integrity verification, consistency checking, and selection by downstream components such as brokers or verifiers. Including such metadata may ensure that revocation data shards may be interpreted correctly even when delivered independently and may enable verifiers to validate authenticity, freshness, and provenance without access to the full revocation list.

The metadata may comprise at least one of: a revocation data number identifying the revocation data, an issuer identifier identifying the certificate authority, and an issuance timestamp indicating when the revocation data was issued. The revocation data number may be a version-like identifier assigned to a given set of revocation data at the time of shard generation. The revocation data number may increment with each issuance cycle, enabling brokers or verifiers to distinguish between newer and older shard groups. The revocation data number may also be used to detect replay or downgrade attempts, such as when a revoked certificate is falsely validated using an outdated shard. Verifiers may use this number in combination with persistent storage to implement rollback protection by rejecting any shard whose revocation data number is lower than a previously accepted one.

The issuer identifier may be a unique value that designates the certificate authority that originally issued both the revoked certificates and the revocation data shards. The issuer identifier may ensure that a shard is only used in conjunction with certificates issued by the corresponding authority and may serve as an integrity check to prevent cross-authority confusion. The issuer identifier may be a name string, a distinguished name (DN), or a hashed public key fingerprint. This metadata element may also support multi-authority environments, in which a verifier needs to distinguish revocation data from different CAs.

The issuance timestamp may indicate the time at which the revocation data set was generated or published. The issuance timestamp may assist in determining freshness, coordinating update intervals, or enforcing policies that require periodic shard renewal. While the verifier may not always have a reliable time source, the timestamp may still serve as a relative indicator when comparing multiple shards, or may be used by brokers or intermediary systems to manage shard cache lifetimes and validity windows. In some configurations, the issuance timestamp may also be embedded as a “This Update” critical extension in the shard format to maintain compatibility with standards such as X.509.

In some examples, the processing circuitry 130 may be further configured digitally sign each revocation data shard with a private key. For example, digitally signing each revocation data shard with a private key may comprise to applying a cryptographic signature over the contents of the shard using a private key held by the certificate authority or the authorized shard issuer. The digital signature may ensure that the revocation data shard cannot be tampered with or forged, and that a verifier or intermediary receiving the shard can authenticate its origin and verify its integrity. The signature may be generated using a standard public key cryptographic algorithm such as RSA, ECDSA, or EdDSA, and may be appended to the shard or embedded as part of an encapsulated X.509-compatible structure. In some examples, the processing circuitry 130 may first assemble the revocation data shard by collecting the selected certificate identifiers and any associated metadata, such as the issuance time range or shard group number. The processing circuitry 130 may then compute a cryptographic digest over the shard contents and use a private key associated with the certificate authority to generate a digital signature over the digest. This signature may be attached to the shard as a separate field, or encoded as part of a defined format such as a CMS (Cryptographic Message Syntax) structure, an X.509 CRL extension, or a signed JSON or CBOR object. Digitally signing each shard may allow downstream entities, such as brokers or verifiers, to validate that the shard was generated by a trusted authority and has not been altered in transit. This mechanism ensures the authenticity and integrity of the revocation data and prevents attacks such as shard spoofing or data injection.

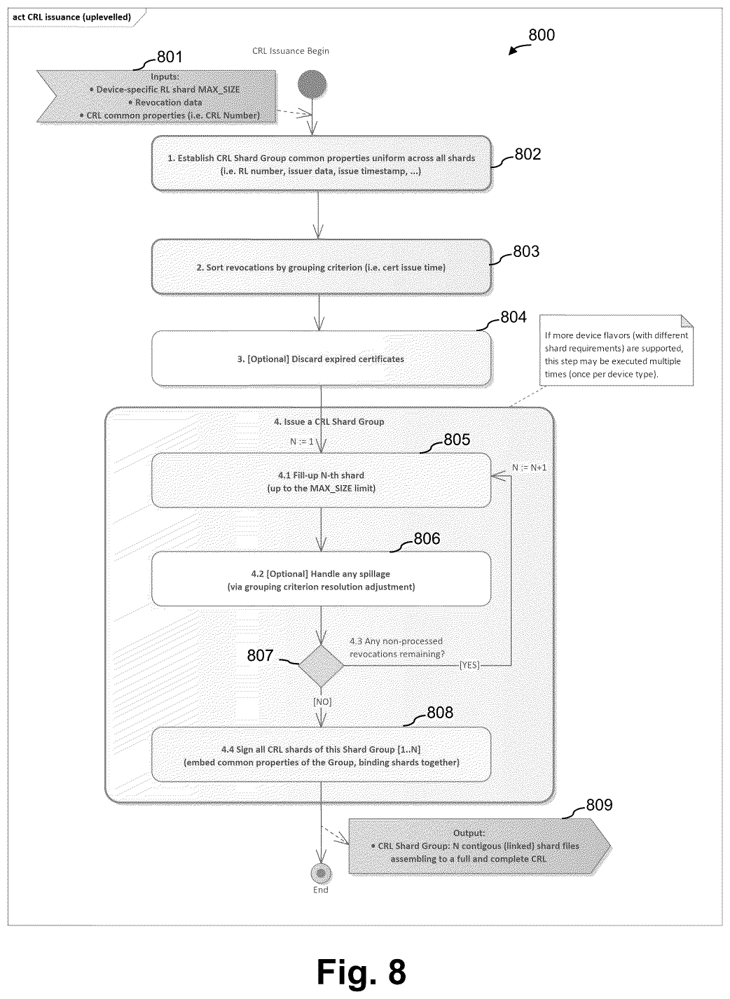

In some examples, the revocation data issuing authority (such as the CA) may also pre-compute the total number of shards within a group and embed a sequential number of a shard as well as the total count (M of N) alongside the grouping criterion metadata, so that a downstream consumer (such as the Broker) may check the received shard group for completeness (all N shards received), and also request a retransmit of a given shard in case of corruption, by requesting it by its sequence number. The total number of shards may either be pre-computed by the CA either ahead of shard issue, or by using a 2-pass issue algorithm, where in the 1st pass the revocations are only put into corresponding shard ‘buckets’ (think: dry-run mode) to establish their grouping and total count, and in the 2nd pass they're actually issued (signed) (see also step 808 in FIG. 8 which operates in this mode already, with actual signing decoupled).

In some examples, the broker may interact with the certificate authority to request a selective re-partitioning of an individual revocation data shard in order to support a newly encountered or more constrained verifier device. For example, if the broker determines that the verifier is unable to process a full revocation data shard due to its size exceeding an implementation-specific threshold, the broker may request the certificate authority to split an existing shard into smaller sub-shards. This may be performed without requiring reissuance of the entire shard group, thereby maintaining backward compatibility and minimizing processing overhead. For example, a shard group contains shard S2 covering certificates issued from January 2023 to December 2023 and having a size of 100 bytes. If the verifier can only process 50-byte shards, the broker may request the certificate authority to split S2 into two sub-shards: S2.1 covering January to June 2023, and S2.2 covering July to December 2023. The resulting shard group for this verifier may thus include S1, S2.1, S2.2, and S3, where only shard S2 is subdivided to accommodate the constrained verifier. In such cases, the metadata associated with each sub-shard may indicate its relationship to the original shard and to the shard group, for example by specifying that S2.1 is part 1 of 2 of a refined partitioning of shard S2. This mechanism may allow shard groups to remain logically complete while supporting adaptive, verifier-specific refinements at the request of the broker.

The processing circuitry 130 is further configured to provide the plurality of revocation data shards to a broker configured to perform communication between the requester and the verifier. For example, the broker may be a component configured to intermediate between the requester and the verifier by selecting, and transmitting revocation data shards. In some examples, the broker (for example, apparatus 200, see FIG. 2) may operate within the same physical device as the requester or in a separate environment and may serve as a resource-rich intermediary that performs processing tasks not feasible within a constrained verifier. The broker may be responsible for selecting an appropriate revocation data shard from the plurality of revocation data shards based on the certificate that is to be verified. This selection may be performed using metadata such as the certificate's issuance time or grouping criteria derived from the certificate's attributes. The broker may then transmit the selected shard, along with the certificate itself, to the verifier for validation.

Apparatus 100 may enable efficient and scalable management of certificate revocation information by generating a plurality of revocation data shards based on revocation data. By partitioning the revocation data into smaller, structured shards that each cover a defined certificate issuance time range, apparatus 100 may facilitate revocation checking in resource-constrained environments, where access to a complete certificate revocation list is impractical. Apparatus 100 may incorporate additional features such as shard size constraints, verifier-specific shard groups, and metadata embedding to tailor the revocation data output to the specific requirements of diverse verifier devices or platforms. This selective structuring may reduce memory and processing demands on the verifier and enable robust certificate validation even in air-gapped or offline scenarios.

Apparatus 100 may further provide enhanced integrity and verifiability of the revocation data shards by digitally signing each shard using a private key associated with the certificate authority. This may allow downstream components, such as brokers or verifiers, to authenticate the origin and integrity of the shards without relying on trusted network connectivity. Apparatus 100 may also embed metadata into each shard, including a revocation data number, issuer identifier, and issuance timestamp, enabling consistency checks, freshness enforcement, and rollback protection mechanisms. By generating and managing cryptographically verifiable, scoped revocation data distributions, apparatus 100 may form the foundation for a secure and lightweight certificate validation infrastructure in distributed and embedded systems.

In some examples, the processing circuitry 130 may be further configured to remove identifiers of revoked certificates from the revocation data which were issued prior to a predetermined cutoff time, before generating the revocation data shards. For example, removing identifiers of revoked certificates from the revocation data which were issued prior to a predetermined cutoff time may comprise a filtering operation in which revoked certificates that fall outside a defined issuance window are excluded from further processing during shard generation. The cutoff time may act as a temporal boundary, such that any certificate that was issued before that time is considered outside the relevant scope of current revocation validation and its issuance date is omitted from the ‘in scope’ date range of the entire shard group. In some examples, the processing circuitry 130 may determine the issuance time of each revoked certificate in the revocation data, for instance by referencing metadata associated with the certificate such as the NotBefore field in X.509 format. The processing circuitry 130 may then compare each issuance time to a predefined cutoff time. If the certificate was issued earlier than this cutoff, its identifier may be excluded from the set of identifiers used to generate the revocation data shards. The cutoff time may be fixed or configurable, and may be selected based on system policy, certificate lifetime profiles, or verifier-specific validity requirements.

In some examples, a certificate C1 may be issued on Jan. 1, 2025, at 12:00:00 and is valid for one month; certificate C2 may be issued on Feb. 1, 2025, at 12:00:00 and is valid for two months; and certificate C3 may be issued at the same timestamp as C2 but has a longer validity period of six months. As of Apr. 29, 2025, both C1 and C2 are known to have expired, while C3 remains valid. If the certificate authority were to generate a new shard group on this date, it would not be possible to exclude C2 from the issuance time range covered by the shard group without also excluding C3, since both certificates share the same issuance timestamp. Therefore, in this case, only C1 may be excluded by defining the shard group to begin at Feb. 1, 2025.

This removing step may serve to reduce the volume of revocation data processed and distributed, and to optimize the resulting shard group for practical use by constrained verifier devices. Omitting old, revoked certificates can be part of a deliberate strategy to allow rough expiry filtering by selectively managing shard availability. For example, if the verifier is known to only accept certificates issued in the last 12 months, then there is no need to generate or store shards that cover issuance time ranges older than that. By excluding identifiers prior to the cutoff time, the certificate authority may avoid generating unnecessary shards, thus reducing computational and storage overhead for both the issuer and downstream components. This approach may also indirectly enforce a form of expiration handling (also described below with regards to FIG. 3): if a certificate is long expired and no shard is generated for its issuance time range, then the certificate will implicitly fail verification due to the absence of a matching shard. This “shard omission” behavior may allow the verifier to reject stale certificates without requiring access to full CRLs or wall-clock time. As a result, the system may support highly efficient and secure revocation checking tailored to the expected operational lifetime of deployed certificates.

Coming back to the size of the shards. In some examples, the processing circuitry 130 may be further configured to obtain a predefined maximum shard size threshold defined by the verifier. The processing circuitry 130 may be further configured to generate the plurality of revocation data shards such that their respective sizes are below the predefined maximum shard size threshold. For example, the maximum shard size threshold may be a parameter that defines an upper limit on the size of a revocation data shard, such that the shard can be reliably stored, transmitted, and processed by the verifier with limited memory or bandwidth. The threshold may be defined in bytes or in terms of the number of certificate identifiers included in each shard. The maximum shard size threshold may be determined in advance and communicated to the processing circuitry 130.

In some examples, the processing circuitry 130 may be configured to obtain the maximum shard size threshold from a configuration file, a secure memory location, or through communication with the requester and/or the verifier via the interface circuitry 120. The threshold may be specified as part of a verifier profile or as a deployment constraint for a particular device class. Once obtained, the processing circuitry 130 may use this threshold as a constraint during the shard generation process. The revocation data may be grouped and assembled into revocation data shards in such a way that the size of each resulting shard does not exceed the threshold. This may involve limiting the number of identifiers per shard or adjusting the boundaries of grouping criteria (e.g., narrowing time ranges or fingerprint prefixes) until the resulting shard fits within the allowable size.

This size-constrained shard generation may enable compatibility with verifiers that operate in embedded environments or air-gapped systems where memory, buffer space, or secure processing capacity is limited. For example, a verifier with only 4 KB of secure RAM may define a maximum shard size of 3.5 KB to ensure that the revocation data shard can be received, verified, and searched without exceeding its processing capabilities. The certificate authority may then generate and sign only such shards that conform to this limit, ensuring interoperability and minimizing resource exhaustion on the verifier side.

In some examples, the processing circuitry 130 may be further configured to generate a plurality of verifier-specific shard groups. For example, the verifier-type specific shard group may refer to a complete set of revocation data shards that, in aggregate, cover the entirety of the revocation data, but are partitioned in a manner that is specifically adapted to the operational constraints of a particular verifier or verifier class. A verifier-specific shard group may contain the same revoked certificate identifiers as another shard group intended for a different verifier, but the division of the identifiers across individual shards may differ based on the verifier's capabilities, such as memory limitations or preferred maximum shard size.

In some examples, a shard group may be a logically grouped collection of revocation data shards that together contain all identifiers from a given revocation data source, such as a certificate revocation list. The revocation data may be sorted and then divided into smaller shards, each shard covering a portion of the data. For one verifier, the data may be split into fewer large shards, while for another verifier with stricter memory or processing limits, the same data may be split into a larger number of smaller shards. Each of these differently partitioned versions may constitute a separate shard group, even though they originate from the same revocation dataset. The generation of verifier-specific shard groups may allow the apparatus 100 to tailor the format of the revocation data to the needs of each verifier. For example, a highly capable verifier may be provisioned with a shard group containing just two large shards, each covering half of the revoked certificate identifiers. In contrast, a memory-constrained embedded verifier may receive the same revocation data as a shard group comprising ten smaller shards, each well below a predefined maximum size threshold. This flexibility improves compatibility with diverse deployment environments while maintaining the integrity and completeness of the revocation checking process.

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-11).

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, apparatus 200 may implement a broker and/or a requester configured to obtain, store, and manage certificate-based identity credentials and to support certificate verification workflows by providing revocation data to a verifier. The broker may be the component configured to obtain, select, and transmit revocation data shards based on certificate metadata, such as issuance time. In some examples, apparatus 200 may operate in a resource-diverse execution environment in which the broker functions in a general-purpose or higher-privilege domain, while the requester or its associated key material may be confined to a trusted environment such as a secure enclave or dedicated secure memory. The coordinated operation of the broker and the requester within apparatus 200 may enable revocation-aware identity proofing in embedded or offline systems.

The processing circuitry 230 is configured to obtain a certificate issued by a certificate authority. The certificate is configured to enable authentication of an identity of the apparatus to a verifier. For example, the certificate may be a digitally signed data structure that binds identity information of the requester to a corresponding public key. The certificate may serve as a cryptographic assertion, issued by the certificate authority (for example, apparatus 100), affirming that the public key belongs to the requester (for example, the entity operating apparatus 200). Upon presentation to a verifier (for example, apparatus 300), the certificate may allow the verifier to confirm the authenticity of the apparatus's identity and to establish trust in the requester. The certificate may be formatted according to the X.509 standard and may include fields such as the subject identifier, the associated public key, a validity period, and signature data generated by the certificate authority.

The processing circuitry 230 is further configured to store the certificate in a trusted environment. For example, the trusted environment may be a secure hardware- or firmware-based execution domain that is isolated from the general-purpose processing context and protected against unauthorized access or tampering. The trusted environment may provide confidentiality, and integrity guarantees for cryptographic credentials and security-critical operations. In some examples, the trusted environment may be implemented as a Trusted Execution Environment (TEE), such as, Intel SGX, or Intel TDX, or as a discrete secure element or security enclave. Within apparatus 200, the trusted environment may comprise dedicated memory regions, isolated processing resources, or specialized modules configured to store the certificate and its associated private key securely. By storing the certificate in such an environment, apparatus 200 may prevent leakage, spoofing, or unauthorized reuse of identity credentials. This secure storage may serve as the basis for strong, hardware-enforced identity attestation when the apparatus presents the certificate to a verifier during an authentication process.

The apparatus of any one of claims 11 to 13, wherein the processing circuitry is further to execute the machine-readable instructions to store a cryptographic key corresponding to the certificate in the trusted environment.

The processing circuitry 230 is further configured to obtain a plurality of revocation data shards issued by the certificate authority. Each revocation data shard is covering a respective certificate issuance time range and comprising identifiers of revoked certificates issued within that time range. For example, the revocation data shards may be structured subsets of the larger revocation dataset generated the certificate authority (for example by apparatus 100). Each shard may include only those identifiers corresponding to certificates issued during a specific issuance time window, allowing targeted and efficient revocation checking.

In some examples, the plurality of revocation data shards may be obtained before requesting the issuance of the certificate from the certificate authority. This ahead-of-time provisioning approach may allow apparatus 200 to cache or pre-load the revocation data shards relevant to its operational domain or device type in advance, for example during manufacturing, installation, or onboarding. The revocation data shards may be selected based on known issuance time ranges or grouping criteria expected to correspond to the certificate that will later be requested. This enables apparatus 200 to function even in air-gapped or intermittently connected environments, as the required revocation data may already be locally available when the certificate is eventually issued. This approach may be especially advantageous in systems with strict provisioning pipelines or where network access is constrained post-deployment. In some examples, the certificate authority may publish revocation data on a recurring basis, independently of individual certificate issuance events. This may be considered as the “ahead-of-time” revocation data provisioning, wherein a comprehensive revocation list is made available for subsequent use by downstream components. In such configurations, the trusted broker operating within a TEE may be delegated the authority to subdivide the published revocation data into revocation data shards on demand. This delegation may allow the broker to perform just-in-time sharding operations, particularly in constrained or air-gapped environments where the verifier lacks connectivity or processing capacity to manage revocation data independently. The broker may construct a revocation data shard from the aggregated dataset, sign or attest to its authenticity, and transmit it to the verifier alongside the certificate. The verifier may then validate the shard and the certificate based on the broker's attestation and the delegated trust relationship established by the certificate authority.

In some examples, the plurality of revocation data shards may be obtained after requesting the issuance of the certificate from the certificate authority. This just-in-time approach allows the certificate authority or an associated system to generate or select only those revocation data shards that are relevant to the actual issuance time of the newly issued certificate. For instance, once apparatus 200 receives its certificate with a specific issuance timestamp, it may determine the appropriate revocation data shard covering that time range and request that shard. This can reduce the volume of revocation data handled by the requester and enables dynamic, usage-based provisioning of revocation information aligned precisely to the certificate lifecycle.

In some examples, the shard generation responsibility may be delegated to the broker component within apparatus 200, or to an external intermediary operating on behalf of the certificate authority. In this configuration, the broker may act as a shard issuer, dynamically assembling revocation data shards “on the spot” based on current certificate parameters and verifier requirements. This delegated architecture may reduce the burden on the certificate authority by distributing the workload of shard construction and allow for flexible runtime adaptation. For example, the broker may locally generate a shard containing only revoked identifiers relevant to the requester's issuance group, fingerprint prefix, or subject hash bucket, and transmit it alongside the certificate to the verifier. This supports highly scalable and decentralized revocation data delivery, especially in multi-tenant systems or deployments involving large fleets of devices with varying trust policies and update cadences.

In some examples, the processing circuitry 130 may be further configured to store the revocation data shards outside the trusted environment. For example, the revocation data shards may be maintained in general-purpose memory or storage areas of apparatus 200 that do not provide the isolation, integrity, or confidentiality guarantees associated with a trusted environment. In some examples, the revocation data shards may be cached in standard system memory, flash storage, or non-secure buffers accessible by the broker component of apparatus 200. For example, the revocation data shards may be stored in the storage circuitry 240, outside the trusted environment.

The processing circuitry 230 is further configured to select a revocation data shard of the plurality of revocation data shards based on an issuance time of the certificate. For example, after processing circuitry 230 has obtained its certificate from the certificate authority, the processing circuitry 230 may extract the certificate's issuance time, such as from the NotBefore field in an X.509 structure, and use this timestamp to identify which revocation data shard is relevant for verifying that certificate. Each revocation data shard may cover a concrete issuance time range, and only one shard is typically applicable to a given certificate. In some examples, this selection step may be performed by the broker component of apparatus 200, which may iterate through the metadata of the available revocation data shards to determine which shard's time range encompasses the certificate's issuance time. This targeted selection avoids the need to process the full set of revocation data shards and supports efficient verification workflows, especially in systems with limited computational resources. By aligning shard selection directly with certificate issuance metadata, apparatus 200 may ensure accurate and bounded revocation checks.

In some examples, the revocation data shard is selected based on the certificate's issuance time falling within the issuance time range covered by the selected revocation data shard. For example, each revocation data shard obtained by the processing circuitry 230 may include metadata defining a specific issuance time window, such as a start and end date, that delimits the scope of the revoked certificates listed within the shard. The processing circuitry 230 may evaluate this metadata and compare it against the issuance time of the certificate stored in the trusted environment. If the certificate's issuance time falls within the bounds of a shard's issuance time range, then that shard may be selected as the applicable shard for revocation validation. This conditional match may ensure that only the revocation data relevant to the certificate is forwarded to the verifier. Such selection logic may be implemented by the broker component of apparatus 200 and may support highly efficient and deterministic shard identification. This approach allows apparatus 200 to reduce the processing burden on the verifier by providing only the minimal and correct revocation data shard required for validation.

The processing circuitry 230 is further configured to provide the certificate and the selected revocation data shard to the verifier for validation. For example, once apparatus the processing circuitry 230 has selected the revocation data shard corresponding to the issuance time of the certificate, the processing circuitry 230, may transmit both the certificate and the selected shard to a verifier (for example, apparatus 300), for authenticity and revocation checking. This step may occur during the execution of a cryptographic authentication protocol, in which the requester attempts to prove its identity to the verifier by presenting a valid certificate. Along with the certificate, the selected revocation data shard is supplied to enable the verifier to determine whether the certificate has been revoked. By transmitting only the relevant shard instead of the full revocation dataset, apparatus 200 may reduce the bandwidth and processing burden on the verifier. This is particularly advantageous in embedded or offline environments, where the verifier may operate with strict resource constraints and cannot access a complete certificate revocation list.

In some examples, the apparatus 200 may be configured to select the revocation data shard in an offline and/or air-gapped environment. For example, apparatus 200 may be deployed in a setting where no continuous or real-time network connectivity is available, such as in embedded control systems, industrial devices, or secure hardware components operating in isolation from external infrastructure. In such scenarios, the broker component of apparatus 200 may be pre-provisioned with the plurality of revocation data shards and may locally perform the selection of the applicable shard based on the certificate's issuance time, without requiring a connection to the certificate authority or to a central revocation service. By supporting shard selection in offline or air-gapped environments, apparatus 200 may enable revocation-aware certificate validation in constrained, autonomous, or high-security deployments where external communications are restricted or infeasible. This capability may be particularly valuable in systems that require long-term operational integrity without relying on live revocation checking mechanisms such as OCSP or real-time CRL downloads. Apparatus 200 may thus ensure that only the relevant shard, containing just the certificate identifiers applicable to the requester's issuance time, is used and provided to the verifier, even in the absence of network access or trusted clocks.

Apparatus 200 may enable secure and efficient certificate-based identity verification. By obtaining and storing a certificate in a trusted environment, apparatus 200 may ensure the integrity and confidentiality of its identity credentials while operating in potentially untrusted or resource-constrained environments. Through its broker component, apparatus 200 may obtain and manage a plurality of revocation data shards issued by a certificate authority, and may autonomously select the shard relevant to its certificate based on the certificate's issuance time. This selective processing model may minimize memory usage, reduce verification complexity, and eliminate the need for the verifier to handle full revocation datasets. Apparatus 200 may further support revocation-aware authentication even in offline or air-gapped scenarios, enabling it to function without requiring real-time connectivity or a trusted time source. By preloading the necessary revocation data shards and performing shard selection locally, the apparatus 200 may decouple certificate issuance and revocation validation in a secure and scalable manner. The ability to transmit only the applicable certificate and shard to the verifier may enhance system modularity and allow the verifier to operate with minimal processing overhead. This architecture may be particularly well-suited for embedded devices, IoT platforms, and secure modules that must prove their identity under strict operational and resource constraints.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-11).

FIG. 3 illustrates a block diagram of an example of an apparatus 300 or device 300. The apparatus 300 comprises circuitry that is configured to provide the functionality of the apparatus 300. For example, the apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the apparatus 300, in conjunction with the interface circuitry 320. For example, the interface circuitry 320 is configured to exchange information, e.g., with other components inside or outside the apparatus 300 and the storage circuitry 340. Likewise, the device 300 may comprise means that is/are configured to provide the functionality of the device 300.

The components of the device 300 are defined as component means, which may correspond to, or implemented by, the respective structural components of the apparatus 300. For example, the device 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the apparatus 300. Features described in connection with the apparatus 300 may thus likewise be applied to the corresponding device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The apparatus 300 or device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 330 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

In some examples, the verifier may be the n entity configured to evaluate the authenticity of the certificate presented by the requester (for example, apparatus 200, see. FIG. 2), and to establish trust in the identity of the requester based on the result of that evaluation. The verifier of apparatus 100 may be implemented in a resource-constrained environment such as an embedded device or secure execution module, and may operate without access to a complete certificate revocation list or a real-time clock. The requester and the verifier may interact within a cryptographic authentication protocol in which the requester presents the certificate to the verifier to prove its identity. The certificate may serve as a trust anchor that allows the verifier to establish a secure session or grant access to protected resources. For example, a hardware device may act as a requester and present its certificate to a verifier embedded in a host platform. The verifier may then validate the certificate and confirm the authenticity of the device prior to initiating secure communication.

The processing circuitry 330 is configured to obtain a certificate issued by a certificate authority. The certificate authority (for example apparatus 100, see FIG. 1) is configured to enable authentication of an identity of a requester to the apparatus. For example, the certificate may be a cryptographically signed data structure generated by the certificate authority (for example, apparatus 100 of FIG. 1) that binds identity information of the requester to a public key. The certificate may serve as a trust anchor that allows the verifier to establish the authenticity of the requester's claimed identity during an authentication procedure. Obtaining the certificate may comprise accepting a transmission from the broker component or directly from the requester, containing the signed certificate data in a standardized format such as X.509. In some examples, the certificate may encapsulate identity fields, validity parameters, and a digital signature created using the private key of the certificate authority.

The processing circuitry 330 is further configured to obtain a revocation data shard. The revocation data shard covers a certificate issuance time range and comprises identifiers of previously issued certificates that were issued by the certificate authority within that time range and have been revoked. As described above, for example, the revocation data shard may be a discrete subset of revocation data, structured to cover only a specific certificate issuance time range and comprising identifiers of certificates issued by the certificate authority that have subsequently been revoked. Obtaining the revocation data shard may enable the apparatus 300 to perform certificate revocation validation in a resource-efficient manner, without requiring access to a complete certificate revocation list. The revocation data shard may include metadata defining the applicable issuance time range, such as a start and end date, and may contain identifiers such as certificate serial numbers, public key fingerprints, or hashes of subject names corresponding to revoked certificates within that range. The revocation data shard may be transmitted to the apparatus 300 together with the certificate, for example by a broker component associated with the requester, ensuring that the verifier has all the necessary information to check the revocation status of the presented certificate. By obtaining only the relevant shard, the apparatus 300 may minimize memory usage and processing requirements, thereby supporting revocation checking even in embedded or offline environments.

The processing circuitry 330 is further configured to verify the validity of the certificate based on the issuance time of the certificate and the certificate issuance time range of the revocation data shard. For example, the apparatus 300 may parse the issuance time metadata embedded in the certificate and compare it against the issuance time range indicated in the received revocation data shard. This verification step may ensure that the correct revocation data shard is being used for validating the certificate and that no irrelevant or outdated revocation data is applied. If the certificate's issuance time falls within the issuance time range of the shard, the processing circuitry 330 may proceed to check whether the certificate identifier is listed as revoked. By aligning the revocation check with the issuance time metadata, processing circuitry 330 may achieve highly efficient and precise certificate validation, minimizing unnecessary shard searches and reducing computational overhead. This design may be beneficial for resource-constrained verifiers, such as embedded devices or air-gapped systems, where full revocation list processing is impractical and selective shard-based validation enables lightweight and scalable authentication workflows.

In some examples, verifying the validity of the certificate may comprise checking if the certificate's issuance time falls within the certificate issuance time range of the revocation data shard. Further, the certificate may be rejected if the issuance time does not fall within the certificate issuance time range of the revocation data shard. In some examples, the checking operation may involve extracting the issuance time from the certificate, such as from a NotBefore field in an X.509 format certificate, and comparing this timestamp against the bounds of the issuance time range associated with the obtained revocation data shard. The issuance time range may define a start and end date delimiting the certificates whose identifiers are included within the shard. If the issuance time of the certificate falls within the defined issuance time range, the shard may be considered applicable for revocation status checking of the certificate. Otherwise, if the issuance time does not fall within the certificate issuance time range of the revocation data shard, the processing circuitry 330 may reject the certificate without further processing, thereby preventing the acceptance of a certificate that cannot be reliably verified using the provided shard.

This checking step may serve as a lightweight validation that ensures the integrity of the verification process even before considering whether the certificate is explicitly listed as revoked. By verifying that the issuance time of the certificate aligns with the intended scope of the shard, the verifier may avoid false negative or false positive validation outcomes that could arise if an irrelevant shard were mistakenly applied. This mechanism may also contribute to attack resistance by thwarting attempts to present certificates to verifiers along with stale, mismatched, or incomplete revocation data shards. In some examples, this approach may offer significant operational advantages. By performing an issuance time range check first, the verifier may quickly and deterministically determine the applicability of the revocation data shard, reducing computational load and memory usage. This feature may be particularly important in embedded verifiers or secure modules that lack the capacity to process full certificate revocation lists (CRLs) or conduct exhaustive searches across all available shards. Furthermore, this issuance time validation may contribute to freshness enforcement, allowing the verifier to reason about the relative validity window of the revocation data shard even in the absence of a trusted real-time clock. For example, if the verifier only accepts certificates whose issuance time falls within a trusted, shard-defined range, then stale or obsolete certificates may be automatically rejected without relying on wall-clock timestamps. This mechanism, therefore, supports highly efficient, bounded, and decentralized certificate verification suitable for air-gapped, low-resource, or intermittently connected environments.

In some examples, verifying the validity of the certificate comprises checking if the certificate is listed as revoked in the revocation data shard. Further, the certificate may be rejected if it is listed. In some examples, verifying the validity may involve searching the revocation data shard for an identifier corresponding to the certificate presented by the prover. The identifier may, for example, be the serial number of the certificate, a fingerprint derived from the certificate's public key, or another unique certificate identifier. The revocation data shard may contain a collection of such identifiers, each representing a certificate that has been revoked by the certificate authority. If the identifier of the presented certificate is found within the revocation data shard, the processing circuitry 330 may determine that the certificate has been revoked and may reject the certificate accordingly. Conversely, if the identifier is not found in the revocation data shard and the issuance time of the certificate matches the issuance time range of the shard, the certificate may be considered not revoked and may proceed to the next steps of authentication or session establishment.

This revocation check within the selected shard may serve as a critical security measure, allowing the verifier to prevent the acceptance of certificates that have been compromised, misused, or otherwise invalidated by the certificate authority. The checking operation may be implemented efficiently by structuring the revocation data shard for fast lookup operations, for example by organizing the identifiers in a sorted list, a hash table, or a tree structure. For example, the processing circuitry 330 may perform certificate revocation validation locally, without requiring access to the complete CRL or an online certificate status service (OCSP). By receiving only the relevant revocation data shard from the broker or requester, the verifier may reduce memory usage, computational effort, and communication overhead, enabling secure and timely revocation checking even in resource-constrained or offline environments. This method may enhance the robustness of the authentication process and improves the scalability of certificate-based trust infrastructures by enabling distributed and shard-based revocation management.

In some examples, verifying the validity of the certificate may comprise validating the integrity of the revocation data shard based on a digital signature of the certificate authority. In some examples, the revocation data shard may be digitally signed by the certificate authority when it is generated, using a private signing key. The verifier may validate this digital signature upon receipt to ensure that the revocation data shard has not been tampered with, modified, or spoofed during transmission or storage. The validation process may involve verifying the digital signature using the public key of the certificate authority, which may be obtained securely and trusted by the verifier. If the digital signature verification succeeds, the verifier may confirm that the revocation data shard is authentic and originates from the certificate authority. If the signature verification fails, the verifier may reject the shard and refuse to perform revocation checking based on its contents. Verifying may provide an important security advantage by ensuring the authenticity and integrity of the revocation data shard before relying on it to make critical trust decisions. For example, digitally signing the revocation data shards and verifying these signatures at the verifier side may prevent attacks such as shard forgery, stale shard replay, and unauthorized revocation status manipulation.

In some examples, the processing circuitry 330 may be further configured to transmit a predefined maximum size threshold of the revocation data shard to the certificate authority (for example, apparatus 100, see FIG. 1) before generating the revocation data shard. In some examples, the verifier may have resource constraints, such as limitations on available memory, buffer size, or processing capability, which impose strict limits on the size of the revocation data that the verifier can handle. The predefined maximum size threshold may define the upper limit for an acceptable shard size, expressed in bytes or by the number of revoked certificate identifiers contained within a shard. The processing circuitry 330 may transmit this maximum shard size threshold to the certificate authority in advance, for example during system setup, device registration, or protocol negotiation. By communicating this constraint, the verifier may ensure that the generated revocation data shards are tailored to its operational capabilities, thereby guaranteeing compatibility and avoiding failures due to oversized revocation data objects.

In some examples, the revocation data shard may have a size that does not exceed a predefined maximum size threshold. The certificate authority, upon receiving the maximum size threshold from the verifier, may generate the revocation data shards accordingly, ensuring that each shard remains within the specified limit. For example, during the shard generation process, the certificate authority may group revoked certificate identifiers into shards such that each shard's cumulative size or identifier count does not exceed the threshold provided by the verifier. This approach may allow a verifier to efficiently receive, validate, and search revocation data without exceeding its available memory or processing budget. This mechanism may provide a technical advantage by enabling efficient interoperability between the certificate authority and highly resource-constrained verifiers. For example, generating revocation data shards according to verifier-specific size thresholds may significantly improve scalability and performance in embedded systems, air-gapped devices, and secure modules, where conventional full CRL handling would be impractical.

In some examples, the processing circuitry 330 may be further configured to store a revocation data number associated with a most recently accepted revocation data shard. The processing circuitry 330 may be configured to reject a subsequently obtained revocation data shard having a revocation data number indicating an earlier issuance than the stored revocation data number. In some examples, the revocation data number may be stored in a rollback-protected persistent memory. The revocation data number may represent, for example, a monotonic value such as a revocation list number or issuance timestamp that indicates the relative freshness of the shard within a shard group. Upon receiving a new revocation data shard for a subsequent verification operation, the verifier may compare the revocation data number of the received shard with the stored identifier. If the identifier of the received shard indicates an earlier issuance than the stored identifier, the verifier may reject the shard and the associated certificate, thereby preventing downgrade or rollback attacks.

This mechanism enables secure validation of certificates across multiple sessions or device interactions, even in the absence of a trusted time source. For example, if a first prover provides a revocation data shard with an identifier RL₁ and the verifier accepts it during an initial session, and a second prover later provides a shard with identifier RL₂, which is newer, the verifier may update the stored identifier to RL₂. If, in a later interaction, the first prover attempts to present the older shard (RL₁) again, the verifier detects the rollback and rejects the shard due to its identifier being lower than the stored RL₂. In this manner, the verifier enforces a strict monotonic revocation threshold, ensuring that only revocation data shards with identifiers equal to or greater than the most recently accepted shard can be processed. This rollback-protection mechanism may be particularly valuable in air-gapped, offline, or constrained environments where traditional time-based freshness validation is not feasible.

In some examples, the broker component may be part of the apparatus 300 together with the verifier. For example, the broker deployed on the same device as the verifier, or integrated within the verifier's host system, may be provisioned with a shard group in advance to support authentication workflows with devices or services expected to present newly issued certificates.

In some examples, the plurality of revocation data shards may be obtained by the broker before requesting the issuance of the certificate from the certificate authority. For example, the broker may already possess the full set of relevant shards at the time the requester initiates certificate issuance, thereby enabling efficient shard selection and offline validation. This ahead-of-time provisioning approach may allow apparatus 200 to cache or pre-load the revocation data shards relevant to its operational domain or device type in advance, for example during manufacturing, installation, or onboarding. The revocation data shards may be selected based on known issuance time ranges or grouping criteria expected to correspond to the certificate that will later be requested. This enables apparatus 300 to function even in air-gapped or intermittently connected environments, as the required revocation data may already be locally available when the certificate is eventually issued. This approach may be especially advantageous in systems with strict provisioning pipelines or where network access is constrained post-deployment.

In some examples, the revocation data shards may be obtained after requesting the issuance of the certificate from the certificate authority.

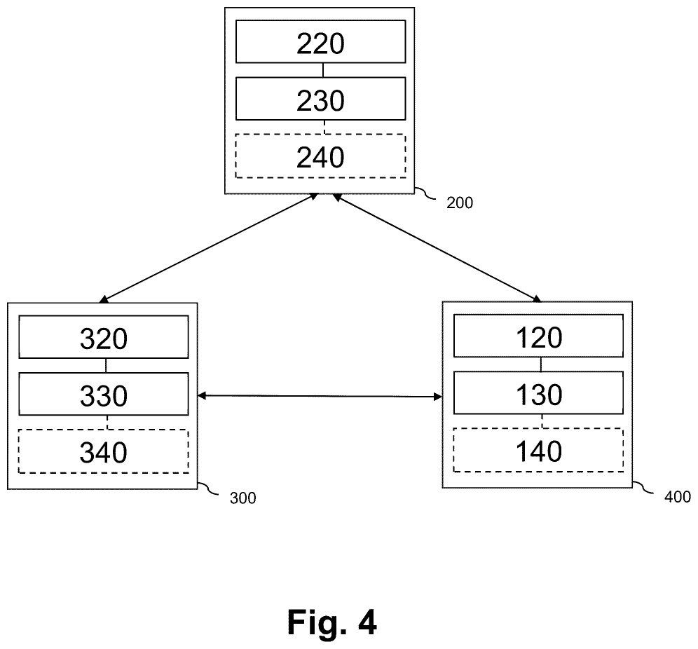

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-11).

FIG. 4 illustrates an example of a system 400. System 400 comprise apparatus 100 (see FIG. 1), apparatus 200 (see FIG. 2) and apparatus 300 (see FIG. 3). Apparatuses 100, 200 and 300 may be coupled communicatively, for example via their respective interface circuitry. Apparatus 100 may be configured as described above with regards to FIG. 1. Apparatus 200 may be configured as described above with regards to FIG. 2. Apparatus 300 may be configured as described above with regards to FIG. 3.

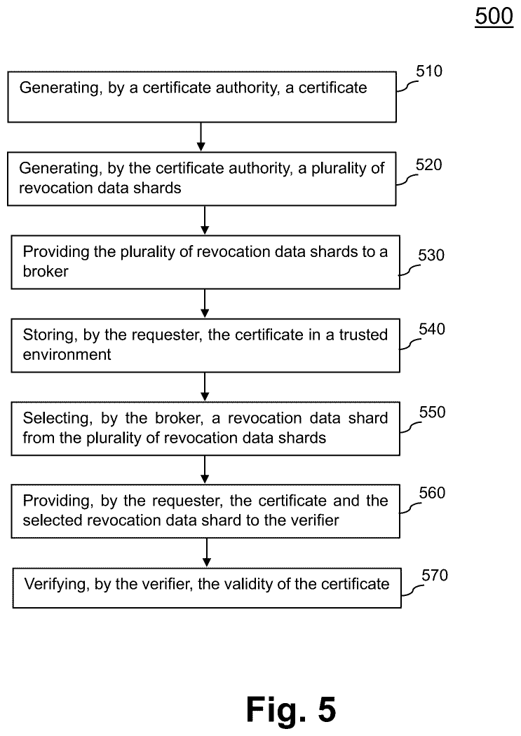

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-11).

FIG. 5 illustrates a flowchart of an example of a method 500. The method 500 may, for instance, be performed by one or more apparatuses as described herein, such as apparatus 100, apparatus 200 and/or apparatus 300. The method 500 comprises generating 510, by a certificate authority, a certificate configured to enable authentication of an identity of a requester to a verifier.

The method 500 further comprises generating 520, by the certificate authority, a plurality of revocation data shards based on revocation data, the revocation data comprising identifiers of previously issued certificates that have been revoked. Each revocation data shard covering a respective certificate issuance time range and comprising identifiers of revoked certificates issued within that time range. The method 500 further comprises 530 the plurality of revocation data shards to a broker. The method 500 further comprises storing 540, by the requester, the certificate in a trusted environment. The method 500 further comprises selecting 550, by the broker, a revocation data shard from the plurality of revocation data shards based on an issuance time of the certificate. The method 500 further comprises providing 560, by the requester, the certificate and the selected revocation data shard to the verifier. The method 500 further comprises verifying 570, by the verifier, the validity of the certificate.

For example, verifying, by the verifier, the validity of the certificate may be based on including its non-revoked, non-expired status based on the provided revocation data shard, which may be linked to the certificate based on issuance time (or, for example, another immutable property of the certificate, established ahead of time)

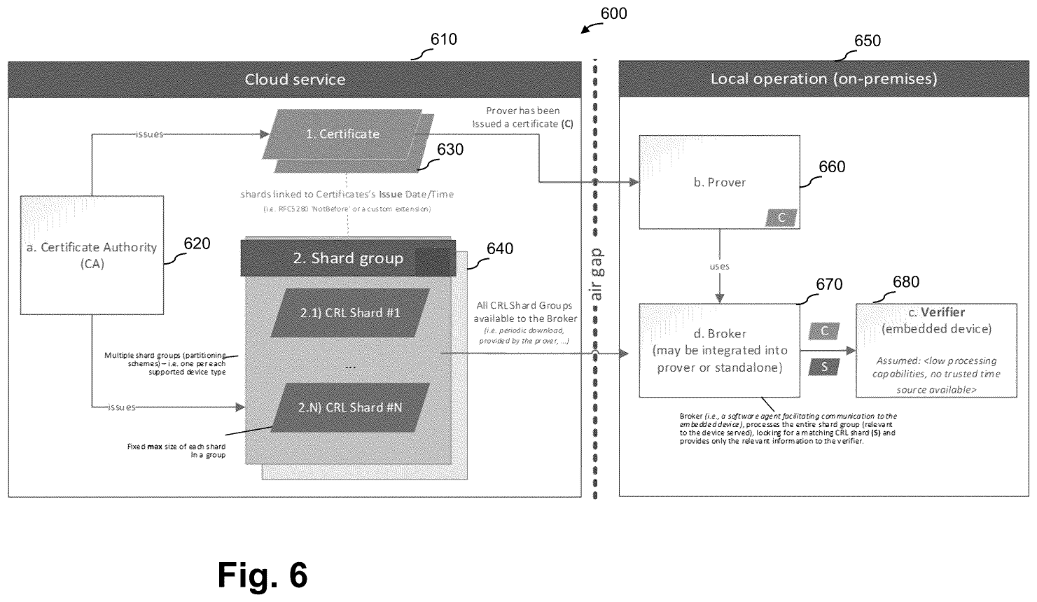

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-11).

### Further Examples

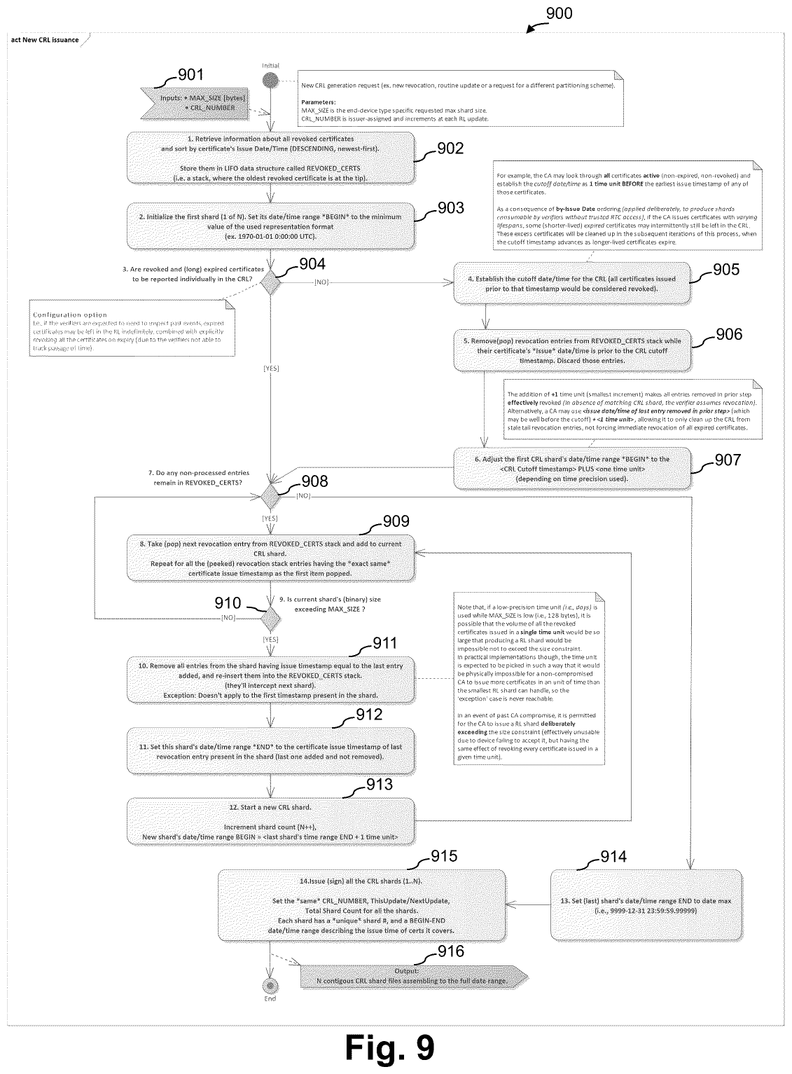

FIG. 6 illustrates an example of system 600 comprising a certificate authority, a prover, a broker and a verifier. The system 600 comprises a cloud service environment 610 and a local operation environment 650 (on-premises), separated by an air gap. The cloud service environment 610 comprises a certificate authority (CA) 620 (for example, apparatus 100, see FIG. 1) which is configured to issue certificates 630 and shard groups 640. The CA 620 may issue certificates that are configured to authenticate an identity of a prover (for example, apparatus 200, see FIG. 2) to a verifier (for example, apparatus 300, see FIG. 3). For example, the certificates 630 may be issued using an RFC 5280-compatible X.509 data format, wherein each certificate binds a public key to identity information of a requester. In addition to issuing certificates, the CA 620 is configured to generate sharded Certificate Revocation Lists, organized into shard groups 640. Each shard group may be a full, self-contained partitioning of the revocation data, meaning that the shard group as a whole represents a complete Certificate Revocation List. Multiple shard groups may be issued depending on device types or partitioning criteria, with a fixed maximum size constraint for each shard. The issuance behavior for shard groups is further detailed in FIG. 9.

The certificate 630 and the shard groups 640 may be made available to the prover 660 operating in the local operation environment 650. The prover (also referred to as requester) 660 represents a CA-certified entity seeking to authenticate itself to the verifier 680. The prover 660 may reside in a cloud or on-premises environment 650 and may operate as an independent service, a device component, or another system co-located with the verifier 680. In particular, the prover 660 may use the issued certificate 630 and the appropriate revocation data shard to support its authentication.

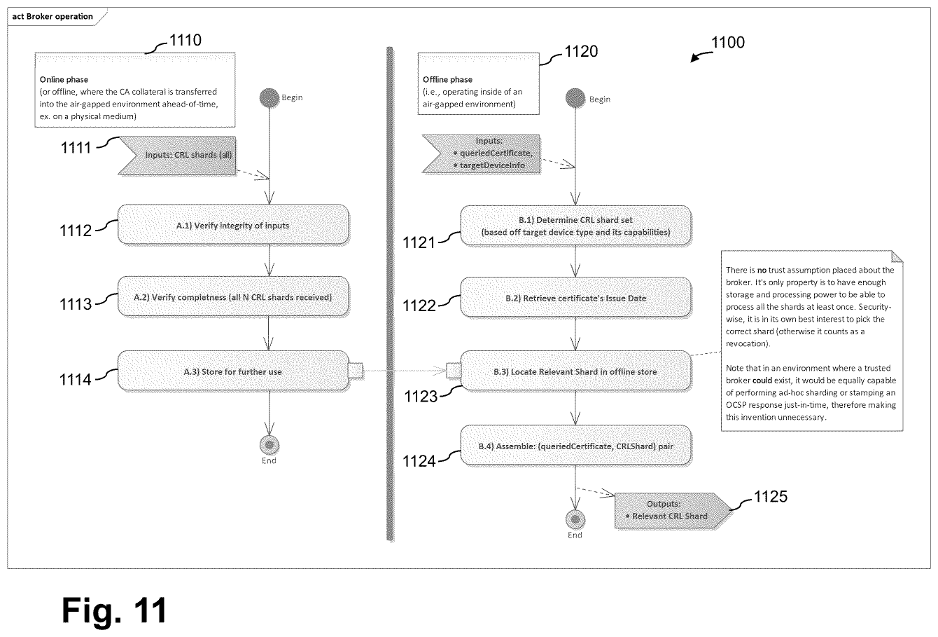

A broker 670 (which may be integrated into the prover 660 or may exist as a standalone component) is configured to assist in selecting and preparing the revocation data for the verifier 680. The broker 670 processes the available shard groups, selects the appropriate shard based on the issuance time of the prover's certificate, and forwards the selected shard together with the certificate to the verifier 680. The broker 670 resides entirely outside the verifier's trusted boundary and operates without imposing processing or memory burdens on the verifier. The behavior and operation of the broker 670 are described in more detail in FIG. 11.

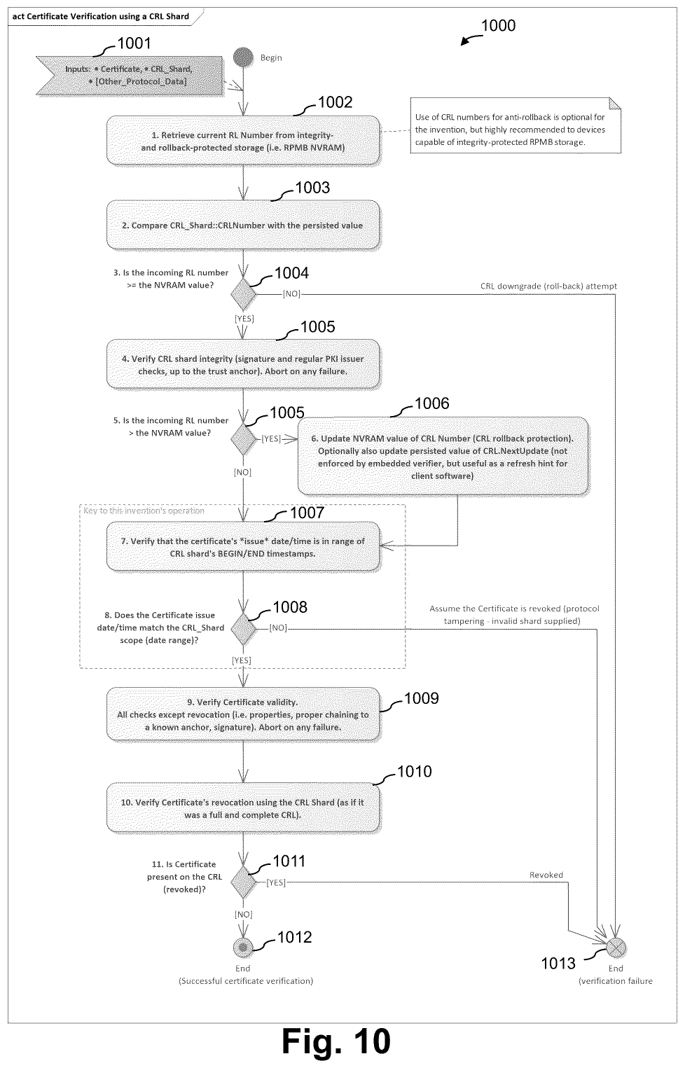

The verifier 680 (for example, apparatus 300) is an embedded device characterized by limited processing capabilities and the absence of a trusted time source. The verifier 680 is tasked with authenticating the identity of the prover 660 and verifying the revocation status based on the received certificate and the revocation data shard. The verifier 680 does not directly retrieve or process complete CRLs and instead relies on the broker 670 to supply a pre-selected shard containing only the relevant revocation information. The detailed operation of the verifier 680, including its resource constraints and verification steps, is explained in FIG. 10

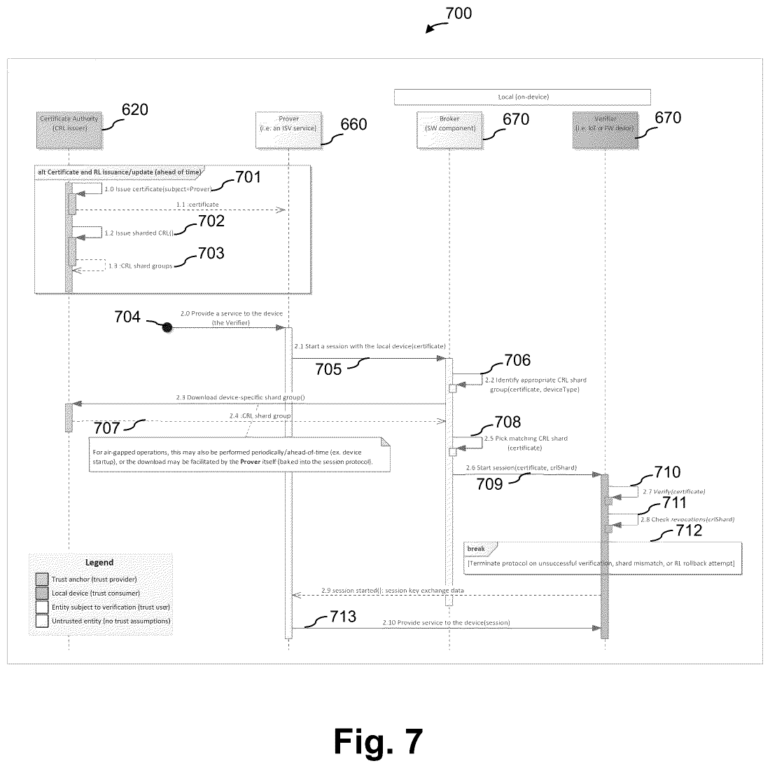

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-11).

FIG. 7 illustrates an example process 700 for an end-to-end authentication and revocation verification flow between a prover, a broker, and a verifier, supported by a certificate authority. The process 700 shows interactions between a cloud service environment (comprising a certificate authority 620) and a local operation environment (comprising a prover 660, a broker 670, and a verifier 680). The process 700 facilitates an authenticated session between the prover 660 and the verifier 680, with the broker 670 assisting in the selection and delivery of appropriate revocation data shards. The broker 670 may be kept outside the trust boundary of the verifier 680 and serves as an untrusted helper component for CRL shard management. In step 701, the certificate authority 620 issues a certificate for the prover 660. This certificate binds a public key to the identity of the prover 660 in a manner compatible with standard X.509 public key infrastructure formats. In step 702, the certificate authority 620 issues a sharded Certificate Revocation List (CRL) by partitioning the revocation data into shard groups, each covering different issuance criteria, for example issuance time ranges or other bucketing strategies. In step 703, multiple CRL shard groups are generated and made available to the broker 670 and the prover 660. At step 704, the prover 660 initiates a service interaction with the verifier 680. This may correspond to the prover 660 requesting authentication or service access at the verifier 680. In step 705, the prover 660 starts a session with the verifier 680. This may involve exchanging session setup information including the prover's certificate. At step 706, the broker 670 identifies the appropriate CRL shard group, based on parameters such as the certificate's issuance time or the device type of the verifier 680. At step 707, the prover 660 and/or broker 670 downloads the device-specific shard group. In some examples, for air-gapped operations, the shard group download may be performed ahead-of-time during device manufacturing or provisioning or may be baked into the device's local storage. In step 708, the broker 670 selects the matching CRL shard that covers the certificate of the prover 660. At step 709, the prover 660 starts a session with the verifier 680 by transmitting both the certificate and the selected CRL shard. In step 710, the verifier 680 verifies the certificate presented by the prover 660, for example by validating its digital signature and evaluating its issuance parameters. In step 711, the verifier 680 checks the revocation status of the certificate against the received CRL shard to determine whether the certificate has been revoked. If the certificate verification or the revocation check fails, or if there is a shard mismatch or rollback detection, the session may be terminated as indicated by the break condition at step 712. If successful, in step 713, the prover 660 proceeds to provide a service to the verifier 680 or complete the authenticated session.

In some examples, the verifier 680 may have a pre-established trust relationship with the broker 670 and to delegate all trust verification and session establishment logic to the broker 670. This architecture may simplify verifier logic at the cost of moving the trust anchor to the broker and may enable flexible cryptographic agility, allowing a broker to update its cryptographic capabilities independently of constrained verifier devices.

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIGS. 8-11).

FIG. 8 illustrates an example process 800 for the issuance of revocation data shards by a certificate authority. The process 800 represents a structured, partitioned approach shard generation that supports efficient revocation verification in constrained environments. In some examples, the shard issuance process begins by receiving, as inputs 801, device-specific parameters including a maximum shard size (MAX_SIZE), the complete revocation data (i.e., identifiers of revoked certificates), and the common properties for the shard group such as the CRL number, issuer data, and issuance timestamp. These common properties ensure consistency across all shards in the group. At step 802, the certificate authority establishes CRL shard group common properties, which are made uniform across all shards. For example, the CRL number, issuer information, and the issue timestamp may be consistently applied to every shard within a given shard group, facilitating validation and integrity checking downstream. In step 803, the revocation entries are sorted according to a grouping criterion. In some examples, the grouping criterion may be the issuance time of the certificates, allowing efficient partitioning based on the issuance periods. Other grouping strategies may also be used depending on device type, system policies, or operational considerations. In step 804, an optional discard operation is performed where expired certificates may be filtered out from the revocation dataset. This optional step allows the certificate authority to omit obsolete entries, reducing the overall size of the shard group and optimizing it for devices that only need to validate recent or active certificates. As noted in the figure, if multiple device flavors (with different shard sizing or grouping requirements) are supported, this procedure may be repeated multiple times, once per device type. The shard issuance process continues with step 805, where a CRL shard group is generated. At step 4.1 (805), individual shards are filled sequentially up to the maximum size limit defined for each shard (MAX_SIZE). Shards are filled one after the other (indexed by N=1, 2, . . . , N) until all revocation entries have been processed. In step 806, an optional adjustment may be performed to handle any spillage or edge cases where entries at a boundary of grouping criteria do not fit neatly within size constraints. For example, slight adjustments in grouping resolution or shard boundaries may be applied to accommodate shard size limits without splitting critical logical groupings. At step 807, the process checks whether any unprocessed revocation entries remain. If additional revoked certificates need to be processed, the procedure loops back to step 805 to generate additional shards. Otherwise, the process proceeds with step 808. In step 808, once all shards have been assembled, the certificate authority digitally signs all shards of the shard group. This signature step embeds the common properties of the group into each shard, cryptographically binding the shards together and enabling downstream verifiers to confirm shard integrity and provenance independently. At step 809, the process outputs the shard group. The resulting shard group comprises N contiguous shard files, logically linked together and representing a full and complete Certificate Revocation List suitable for shard-based revocation verification architectures.

Further details and aspects are mentioned in connection with the examples described above or below. The example shown in FIG. 8 may include one or more optional additional features corresponding to one or more aspects mentioned in connection with the proposed concept or one or more examples described above (e.g., FIGS. 1-7) or below (e.g., FIGS. 9-11).

In some examples, FIG. 8 may provide a high-level overview for possible implementations and FIG. 9 may be one example implementation (one of many possible).

FIG. 9 illustrates an example process 900 for generating and issuing a revocation data shards. In step 901, the certificate authority receives as inputs a maximum shard size (MAX_SIZE) expressed in bytes, and a CRL number (CRL_NUMBER) assigned to the CRL issuance operation. These parameters control the size and version tracking of the generated CRL shards. In step 902, information about all revoked certificates is retrieved and sorted by certificate issuance date/time in descending order (i.e., newest certificates first). The revoked certificates are stored in a last-in-first-out (LIFO) data structure referred to as REVOKED_CERTS, such that the most recently issued revoked certificate is processed first. This descending ordering ensures that cutoff timestamps for shard ranges can be effectively managed without requiring trusted real-time clocks on the verifier side. The CA may establish a cutoff timestamp slightly before the earliest issuance time present in the revoked set to allow proper shard boundaries even in cases of non-uniform certificate issuance time precision. In step 903, the first shard is initialized. The shard counter N is set to 1, and the time range BEGIN for the first shard is initialized to the minimum representable date/time value of the used format (for example, 1970-01-01 00:00:00 UTC). In step 904, a configuration check is performed to determine whether revoked and/or long-expired certificates should be reported individually in the CRL. For example, if a system design expects verifiers to need access to past certificates indefinitely, then even expired certificates may be kept in the CRL, and the process proceeds with step 908. Otherwise, expired certificates may be explicitly revoked upon expiry and/or omitted depending on verifier capabilities and the process proceeds with step 905. If expired certificates should not be separately listed, the process continues to step 905, where a cutoff date/time for the CRL is established. All certificates with issuance times prior to this cutoff timestamp are considered revoked and may be purged from further processing. In step 906, revocation entries are removed (popped) from the REVOKED_CERTS stack if their issuance time is earlier than the CRL cutoff timestamp. These entries are discarded unless explicitly required to be retained by configuration. In step 907, the process adjusts the BEGIN time of the first CRL shard to one smallest time unit past the cutoff timestamp. By incrementing the cutoff timestamp by a minimal unit (e.g., one second or millisecond), the CA ensures that no ambiguity exists between certificates falling just before versus after the cutoff. This prevents overlap between shards and allows verifiers to rely on strict shard scoping. In step 908, a check is performed to determine whether any non-processed revocation entries remain in the REVOKED_CERTS stack. If so, the next processing phase begins. In step 909, the next revocation entry is popped from the stack and added to the current shard under construction. All revoked certificates with the same issuance timestamp as the popped entry are collected together, ensuring that certificates issued at the exact same moment are grouped into a single shard for atomicity. At step 910, the binary size of the current shard is checked to determine whether it exceeds the allowed MAX_SIZE. If not, the next revoked entry is processed. If the size limit would be exceeded: In step 911, all entries beyond the current point (except the first popped entry) are reinserted into REVOKED_CERTS for processing in the next shard. This ensures that certificates sharing the exact issuance timestamp remain in the same shard while preventing size overflow. It also ensures compliance even under low-precision time units (e.g., daily resolution), avoiding scenarios where a single revocation timestamp could otherwise exhaust a shard. In step 912, the shard's END time range is set to the issuance time of the last revocation entry included in the shard. In step 913, a new CRL shard is initialized, the shard counter N is incremented, and the new shard's BEGIN time is set to the previous shard's END plus one time unit, ensuring no overlap In step 914, after all revoked entries are processed, the END of the last shard is explicitly set to the maximum representable date (9999-12-31 23:59:59.999999), covering all potential future issuance dates. In step 915, all CRL shards of the group are issued (digitally signed) using the same CRL_NUMBER, update timestamps (ThisUpdate, NextUpdate), and assigned shard sequencing information. Each shard has a unique shard number and associated BEGIN-END issuance time range metadata. The use of issuance timestamps embedded as a dedicated field such as “This Update” field or as a critical extensions in each shard allows verifiers to understand the validity window of each shard without needing real-time clocks, enabling lightweight verification even on constrained embedded devices. At step 916, the final output is a logically contiguous collection of CRL shard files (N shards) that collectively cover the full revocation date range.

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1-8) or below (e.g., FIGS. 10-11).

FIG. 10 illustrates an example process 1000 for verifying a certificate using a revocation data shard at a verifier device. The process 1000 enables a lightweight verifier (for example, apparatus 300, see FIG. 3) to validate a certificate's authenticity and revocation status based on a partial CRL shard without requiring access to a complete CRL or a trusted time source. This process also provides protection against rollback attacks using CRL numbers.

In step 1001, the verifier receives as inputs a certificate, a CRL shard, and optionally, additional protocol data. The process begins by preparing the verifier to authenticate the prover (for example, apparatus 200, see FIG. 2). In step 1002, the verifier retrieves the current stored CRL number from integrity- and rollback-protected storage, such as Replay-Protected Memory Block (RPMB) Non-Volatile RAM (NVRAM). The use of CRL numbers for rollback protection is optional in the invention but highly recommended for devices capable of integrity-protected storage. In step 1003, the verifier compares the CRL number included in the received CRL shard (CRL_Shard:CRLNumber) with the previously stored CRL number. In step 1004, the verifier checks whether the incoming CRL number is greater than or equal to the persisted CRL number. If not (NO branch), a CRL downgrade or rollback attempt is assumed, and the verification fails immediately. This prevents an attacker from replaying an old shard to falsely validate a revoked certificate. In step 1005, if the incoming CRL number is valid, the verifier verifies the integrity of the CRL shard. This includes checking the digital signature of the shard and verifying that it was signed by a trusted certificate authority (the pre-established trust anchor). Any failure results in immediate verification failure. In step 1006, if the CRL number is newer, the verifier updates its stored NVRAM value for the CRL number to the incoming value. Optionally, the verifier may also update persisted hints for CRL:NextUpdate timestamps to help client-side refresh logic, even though such hints are not enforced inside the embedded verifier itself. In step 1007, which is a key part of the invention, the verifier checks that the certificate's issuance time falls within the BEGIN/END time range described by the CRL shard metadata. This time-based scope checking ensures that the shard actually covers the certificate being validated. It prevents attacks where an irrelevant shard is presented. In step 1008, the verifier determines whether the certificate's issuance time is correctly within the shard's time range. If not (NO branch), the certificate is treated as revoked and the protocol fails immediately due to invalid shard scoping (assuming possible tampering). If the issuance time matches the shard's time range (YES branch), the verifier proceeds to step 1009, where it verifies all aspects of the certificate's validity except revocation status. This includes checking signature correctness, chain of trust to a known root, and basic field validity. Any failure at this step aborts the verification. In step 1010, the verifier checks the revocation status of the certificate using the provided CRL shard. The verifier processes the shard as if it were a complete CRL but constrained to the described issuance time range. At step 1011, the verifier checks whether the certificate's identifier (for example, serial number) is listed as revoked within the shard. If the certificate is listed (YES branch), the verifier concludes that the certificate is revoked, and the verification fails at step 1013. If the certificate is not listed in the shard (NO branch), the certificate is considered valid, and the verification succeeds at step 1012

Further details and aspects are mentioned in connection with the examples described above or below. The example shown in FIG. 10 may include one or more optional additional features corresponding to one or more aspects mentioned in connection with the proposed concept or one or more examples described above (e.g., FIGS. 1-9) or below (e.g., FIG. 11).

FIG. 11 illustrates an example of a broker operation process 1100 comprising an online phase 1110 and an offline phase 1120. The broker operation process 1100 enables efficient management of revocation data shards for use in validating certificates in constrained verifier environments. In the online phase 1110, the broker receives and processes CRL shard data ahead of time. In step 1111, the broker receives CRL shards (inputs: CRL shards [all]), for example from a certificate authority (CA) such as apparatus 100 (see FIG. 1). At step 1112, the broker verifies the integrity of the received inputs, ensuring that the CRL shards are correctly signed and authentic. In step 1113, the broker verifies the completeness of the received shard group, confirming that all expected shards have been received. Following successful verification, in step 1114, the broker stores the CRL shards for later use in the offline phase. This storage may occur in a local memory, database, or persistent storage accessible to the broker.

In the offline phase 1120, the broker operates to select the appropriate revocation data shard corresponding to a queried certificate and target device information. In step 1121, the broker determines the applicable CRL shard set based on the target device type and its capabilities. In step 1122, the broker retrieves the issuance date of the queried certificate. In step 1123, the broker locates the relevant CRL shard in its offline store that covers the issuance date of the certificate. In step 1124, the broker assembles a pair comprising the queried certificate and the selected CRL shard. At step 1125, the broker outputs the relevant CRL shard for subsequent validation processing by the verifier (for example, apparatus 300, see FIG. 3).

In some examples, the broker operates outside the verifier's trusted boundary. No trust assumption is placed on the broker; it is merely tasked with pre-processing the CRL shards and providing the minimal necessary revocation information to the verifier. In this way, the broker can operate in environments where verifiers are constrained, air-gapped, or unable to process complete revocation lists. By selecting the relevant shard corresponding to the certificate's issuance time, the broker reduces the burden on the verifier and enables lightweight, efficient revocation validation. This architecture allows the verifier to operate without direct reliance on full CRLs or live online revocation services, improving scalability and robustness of the revocation system.

Further details and aspects are mentioned in connection with the examples described above. The example shown in FIG. 11 may include one or more optional additional features corresponding to one or more aspects mentioned in connection with the proposed concept or one or more examples described above (e.g., FIGS. 1-10).

In the following, some examples of the proposed concept are presented:

An example (e.g., example 1) relates to an apparatus comprising interface circuitry, machine-readable instructions and processing circuitry to execute the machine-readable instructions to issue a certificate, wherein the certificate is configured to authenticate an identity of a requester to a verifier, obtain revocation data comprising identifiers of previously issued certificates that have been revoked, generate a plurality of revocation data shards based on the revocation data, each revocation data shard covering a respective issuance time range and comprising identifiers of revoked certificates issued within that respective time range, and provide the plurality of revocation data shards to a broker configured to perform communication between the requester and the verifier.

Another example (e.g., example 2) relates to a previous example (e.g., example 1) or to any other example, further comprising that the processing circuitry is further to execute the machine-readable instructions to obtain a predefined maximum shard size threshold defined by the verifier, and generate the plurality of revocation data shards such that their respective sizes are below the predefined maximum shard size threshold.

Another example (e.g., example 3) relates to a previous example (e.g., one of the examples 1 to 2) or to any other example, further comprising that each revocation data shard comprises metadata shared across the plurality of revocation data shards, the metadata comprising at least one of a revocation data number identifying the revocation data, an issuer identifier identifying the certificate authority, and an issuance timestamp indicating when the revocation data was issued.

Another example (e.g., example 4) relates to a previous example (e.g., one of the examples 1 to 3) or to any other example, further comprising that the processing circuitry is further to execute the machine-readable instructions to sort the revocation data based on issuance time prior to generating the revocation data shards.

Another example (e.g., example 5) relates to a previous example (e.g., one of the examples 1 to 4) or to any other example, further comprising that the processing circuitry is further to execute the machine-readable instructions to remove identifiers of revoked certificates from the revocation data which were issued prior to a predetermined cutoff time, before generating the revocation data shards.

Another example (e.g., example 6) relates to a previous example (e.g., one of the examples 1 to 5) or to any other example, further comprising that the processing circuitry is further to execute the machine-readable instructions generate a plurality of verifier-specific shard groups.

Another example (e.g., example 7) relates to a previous example (e.g., one of the examples 1 to 6) or to any other example, further comprising that issuing the certificate comprises digitally signing a cryptographic key and identity information received by the requester.

Another example (e.g., example 8) relates to a previous example (e.g., one of the examples 1 to 7) or to any other example, further comprising that the processing circuitry is further to execute the machine-readable instructions to digitally sign each revocation data shard with a private key.

Another example (e.g., example 9) relates to a previous example (e.g., one of the examples 1 to 8) or to any other example, further comprising that the processing circuitry is further to execute the machine-readable instructions to include the respective issuance time range into each revocation data shard as an extension of the X.509 format.

An example (e.g., example 10) relates to an apparatus comprising interface circuitry, machine-readable instructions, and processing circuitry to execute the machine-readable instructions to obtain a certificate issued by a certificate authority, the certificate being configured to enable authentication of an identity of the apparatus to a verifier, store the certificate in a trusted environment, obtain a plurality of revocation data shards issued by the certificate authority, each revocation data shard covering a respective certificate issuance time range and comprising identifiers of revoked certificates issued within that time range, select a revocation data shard of the plurality of revocation data shards based on an issuance time of the certificate, and provide the certificate and the selected revocation data shard to the verifier for validation.

Another example (e.g., example 11) relates to a previous example (e.g., example 10) or to any other example, further comprising that revocation data shard is selected based on the certificate's issuance time falling within the issuance time range covered by the selected revocation data shard.

Another example (e.g., example 12) relates to a previous example (e.g., one of the examples 10 to 11) or to any other example, further comprising that the apparatus is configured to select the revocation data shard in an offline and/or air-gapped environment.

Another example (e.g., example 13) relates to a previous example (e.g., one of the examples 10 to 12) or to any other example, further comprising that the plurality of revocation data shards is obtained before requesting the issuance of the certificate from the certificate authority.

Another example (e.g., example 14) relates to a previous example (e.g., one of the examples 10 to 12) or to any other example, further comprising that the plurality of revocation data shards is obtained after requesting the issuance of the certificate from the certificate authority.

Another example (e.g., example 15) relates to a previous example (e.g., one of the examples 11 to 14) or to any other example, further comprising that the processing circuitry is further to execute the machine-readable instructions to store the revocation data shards outside the trusted environment.

An example (e.g., example 16) relates to an apparatus comprising interface circuitry, machine-readable instructions, and processing circuitry to execute the machine-readable instructions to obtain a certificate issued by a certificate authority, the certificate authority being configured to enable authentication of an identity of a requester to the apparatus, obtain a revocation data shard, wherein the revocation data shard covers a certificate issuance time range and comprises identifiers of previously issued certificates that were issued by the certificate authority within that time range and have been revoked, verify the validity of the certificate based on the issuance time of the certificate and the certificate issuance time range of the revocation data shard.

Another example (e.g., example 17) relates to a previous example (e.g., example 16) or to any other example, further comprising that verifying the validity of the certificate comprises checking if the certificate's issuance time falls within the certificate issuance time range of the revocation data shard, and rejecting the certificate if the issuance time does not fall within the certificate issuance time range of the revocation data shard.

Another example (e.g., example 18) relates to a previous example (e.g., one of the examples 16 to 17) or to any other example, further comprising that verifying the validity of the certificate comprises checking if the certificate is listed as revoked in the revocation data shard, and rejecting the certificate if it is listed.

Another example (e.g., example 19) relates to a previous example (e.g., one of the examples 16 to 18) or to any other example, further comprising that verifying the validity of the certificate comprises validating the integrity of the revocation data shard based on a digital signature of the certificate authority.

Another example (e.g., example 20) relates to a previous example (e.g., one of the examples 16 to 19) or to any other example, further comprising that the processing circuitry is further to execute the machine-readable instructions to transmit a predefined maximum size threshold of the revocation data shard to the certificate authority before generating the revocation data shard.

Another example (e.g., example 21) relates to a previous example (e.g., one of the examples 16 to 20) or to any other example, further comprising that the revocation data shard has a size that does not exceed a predefined maximum size threshold.

Another example (e.g., example 22) relates to a previous example (e.g., one of the examples 16 to 21) or to any other example, further comprising that the processing circuitry is further to execute the machine-readable instructions to store a revocation data identifier associated with a most recently accepted revocation data shard, and reject a subsequently obtained revocation data shard having a revocation data identifier indicating an earlier issuance than the stored revocation data identifier.

An example (e.g., example 23) relates to a system comprising the apparatus of any one of examples 1 to 10, and the apparatus of any one of examples 11 to 15, and the apparatus of any one of examples 16 to 22.

An example (e.g., example 24) relates to a method comprising generating, by a certificate authority, a certificate configured to enable authentication of an identity of a requester to a verifier, generating, by the certificate authority, a plurality of revocation data shards based on revocation data, the revocation data comprising identifiers of previously issued certificates that have been revoked, wherein each revocation data shard covering a respective certificate issuance time range and comprising identifiers of revoked certificates issued within that time range, providing the plurality of revocation data shards to a broker, storing, by the requester, the certificate in a trusted environment, selecting, by the broker, a revocation data shard from the plurality of revocation data shards based on an issuance time of the certificate, providing, by the requester, the certificate and the selected revocation data shard to the verifier, verifying, by the verifier, the validity of the certificate.

Another example (e.g., example 25) relates to a previous example (e.g., example 24) or to any other example, further comprising obtaining a predefined maximum shard size threshold defined by the verifier, and generating the plurality of revocation data shards such that their respective sizes are below the predefined maximum shard size threshold.

Another example (e.g., example 26) relates to a previous example (e.g., one of the examples 24 to 25) or to any other example, further comprising that each revocation data shard comprises metadata shared across the plurality of revocation data shards, the metadata comprising at least one of a revocation data number identifying the revocation data, an issuer identifier identifying the certificate authority, and an issuance timestamp indicating when the revocation data was issued.

Another example (e.g., example 27) relates to a previous example (e.g., one of the examples 24 to 26) or to any other example, further comprising sorting the revocation data based on issuance time prior to generating the revocation data shards.

Another example (e.g., example 28) relates to a previous example (e.g., one of the examples 24 to 27) or to any other example, further comprising removing identifiers of revoked certificates from the revocation data which were issued prior to a predetermined cutoff time, before generating the revocation data shards.

Another example (e.g., example 29) relates to a previous example (e.g., one of the examples 24 to 28) or to any other example, further comprising generating a plurality of verifier-specific shard groups.

Another example (e.g., example 30) relates to a previous example (e.g., one of the examples 24 to 29) or to any other example, further comprising that issuing the certificate comprises digitally signing a cryptographic key and identity information received by the requester.

Another example (e.g., example 31) relates to a previous example (e.g., one of the examples 24 to 30) or to any other example, further comprising digitally signing each revocation data shard with a private key.

Another example (e.g., example 32) relates to a previous example (e.g., one of the examples 24 to 31) or to any other example, further comprising including the respective issuance time range into each revocation data shard as an extension of the X.509 format.

Another example (e.g., example 33) relates to a previous example (e.g., one of the examples 24 to 32) or to any other example, further comprising that revocation data shard is selected based on the certificate's issuance time falling within the issuance time range covered by the selected revocation data shard.

Another example (e.g., example 34) relates to a previous example (e.g., one of the examples 24 to 33) or to any other example, further comprising that an apparatus is configured to select the revocation data shard in an offline and/or air-gapped environment.

Another example (e.g., example 35) relates to a previous example (e.g., one of the examples 24 to 34) or to any other example, further comprising that the plurality of revocation data shards is obtained before requesting the issuance of the certificate from the certificate authority.

Another example (e.g., example 36) relates to a previous example (e.g., one of the examples 24 to 35) or to any other example, further comprising that the plurality of revocation data shards is obtained after requesting the issuance of the certificate from the certificate authority.

Another example (e.g., example 37) relates to a previous example (e.g., one of the examples 24 to 36) or to any other example, further comprising storing the revocation data shards outside the trusted environment.

Another example (e.g., example 38) relates to a previous example (e.g., one of the examples 24 to 37) or to any other example, further comprising that verifying the validity of the certificate comprises checking if the certificate's issuance time falls within the certificate issuance time range of the revocation data shard, and rejecting the certificate if the issuance time does not fall within the certificate issuance time range of the revocation data shard.

Another example (e.g., example 39) relates to a previous example (e.g., one of the examples 24 to 38) or to any other example, further comprising that verifying the validity of the certificate comprises checking if the certificate is listed as revoked in the revocation data shard, and rejecting the certificate if it is listed.

Another example (e.g., example 40) relates to a previous example (e.g., one of the examples 24 to 39) or to any other example, further comprising that verifying the validity of the certificate comprises validating the integrity of the revocation data shard based on a digital signature of the certificate authority.

Another example (e.g., example 41) relates to further comprises transmitting a predefined maximum size threshold of the revocation data shard to the certificate authority before generating the revocation data shard.

Another example (e.g., example 42) relates to a previous example (e.g., one of the examples 24 to 41) or to any other example, further comprising that the revocation data shard has a size that does not exceed a predefined maximum size threshold.

Another example (e.g., example 43) relates to a previous example (e.g., one of the examples 24 to 42) or to any other example, further comprising storing a revocation data identifier associated with a most recently accepted revocation data shard, and rejecting a subsequently obtained revocation data shard having a revocation data identifier indicating an earlier issuance than the stored revocation data identifier.

Another example (e.g., example 44) relates to a computer-readable medium including program code, when executed, to cause a machine to perform the method of any one of examples 24 to 43.

An example (e.g., example 45) relates to an apparatus comprising a processor circuitry configured to issue a certificate, wherein the certificate is configured to authenticate an identity of a requester to a verifier, obtain revocation data comprising identifiers of previously issued certificates that have been revoked, generate a plurality of revocation data shards based on the revocation data, each revocation data shard covering a respective issuance time range and comprising identifiers of revoked certificates issued within that respective time range, and provide the plurality of revocation data shards to a broker configured to perform communication between the requester and the verifier.

An example (e.g., example 46) relates to an apparatus comprising a processor circuitry configured to obtain a certificate issued by a certificate authority, the certificate being configured to enable authentication of an identity of the apparatus to a verifier, store the certificate in a trusted environment, obtain a plurality of revocation data shards issued by the certificate authority, each revocation data shard covering a respective certificate issuance time range and comprising identifiers of revoked certificates issued within that time range, select a revocation data shard of the plurality of revocation data shards based on an issuance time of the certificate, and provide the certificate and the selected revocation data shard to the verifier for validation.

An example (e.g., example 47) relates to an apparatus comprising a processor circuitry configured to obtain a certificate issued by a certificate authority, the certificate authority being configured to enable authentication of an identity of a requester to the apparatus, obtain a revocation data shard, wherein the revocation data shard covers a certificate issuance time range and comprises identifiers of previously issued certificates that were issued by the certificate authority within that time range and have been revoked, verify the validity of the certificate based on the issuance time of the certificate and the certificate issuance time range of the revocation data shard.

An example (e.g., example 48) relates to a device comprising means for processing for issuing a certificate, wherein the certificate is configured to authenticate an identity of a requester to a verifier, obtaining revocation data comprising identifiers of previously issued certificates that have been revoked, generating a plurality of revocation data shards based on the revocation data, each revocation data shard covering a respective issuance time range and comprising identifiers of revoked certificates issued within that respective time range, and providing the plurality of revocation data shards to a broker configured to perform communication between the requester and the verifier.

An example (e.g., example 49) relates to a device comprising means for processing for obtaining a certificate issued by a certificate authority, the certificate being configured to enable authentication of an identity of the apparatus to a verifier, storing the certificate in a trusted environment, obtaining a plurality of revocation data shards issued by the certificate authority, each revocation data shard covering a respective certificate issuance time range and comprising identifiers of revoked certificates issued within that time range, selecting a revocation data shard of the plurality of revocation data shards based on an issuance time of the certificate, and providing the certificate and the selected revocation data shard to the verifier for validation.

An example (e.g., example 50) relates to a device comprising means for processing for obtaining a certificate issued by a certificate authority, the certificate authority being configured to enable authentication of an identity of a requester to the apparatus, obtaining a revocation data shard, wherein the revocation data shard covers a certificate issuance time range and comprises identifiers of previously issued certificates that were issued by the certificate authority within that time range and have been revoked, verifying the validity of the certificate based on the issuance time of the certificate and the certificate issuance time range of the revocation data shard.

Another example (e.g., example 51) relates to a computer program having a program code for performing the method of any one of examples 24 to 43. when the computer program is executed on a computer, a processor, or a programmable hardware component.

Another example (e.g., example 52) relates to a machine-readable storage including machine readable instructions, when executed, to implement a method or realize an apparatus as claimed in any pending claim.

Another example (e.g., example 53) relates to a computer-readable medium including program code, when executed, to cause a machine to perform the method of any one of examples 24 to 43.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
issue a certificate, wherein the certificate is configured to authenticate an identity of a requester to a verifier;
obtain revocation data comprising identifiers of previously issued certificates that have been revoked;
generate a plurality of revocation data shards based on the revocation data, each revocation data shard covering a respective issuance time range and comprising identifiers of revoked certificates issued within that respective time range; and
provide the plurality of revocation data shards to a broker configured to perform communication between the requester and the verifier.

2. The apparatus of claim 1, wherein the processing circuitry is further to execute the machine-readable instructions to:
obtain a predefined maximum shard size threshold defined by the verifier; and
generate the plurality of revocation data shards such that their respective sizes are below the predefined maximum shard size threshold.

3. The apparatus of claim 1, wherein each revocation data shard comprises metadata shared across the plurality of revocation data shards, the metadata comprising at least one of: a revocation data number identifying the revocation data, an issuer identifier identifying the certificate authority, and an issuance timestamp indicating when the revocation data was issued.

4. The apparatus of claim 1, wherein the processing circuitry is further to execute the machine-readable instructions to sort the revocation data based on issuance time prior to generating the revocation data shards.

5. The apparatus of claim 1, wherein the processing circuitry is further to execute the machine-readable instructions to remove identifiers of revoked certificates from the revocation data which were issued prior to a predetermined cutoff time, before generating the revocation data shards.

6. The apparatus of claim 1, wherein the processing circuitry is further to execute the machine-readable instructions generate a plurality of verifier-specific shard groups.

7. The apparatus of claim 1, wherein issuing the certificate comprises digitally signing a cryptographic key and identity information received by the requester.

8. The apparatus of claim 1, wherein the processing circuitry is further to execute the machine-readable instructions to digitally sign each revocation data shard with a private key.

9. The apparatus of claim 1, wherein the processing circuitry is further to execute the machine-readable instructions to include the respective issuance time range into each revocation data shard as an extension of the X.509 format.

10. An apparatus comprising interface circuitry, machine-readable instructions, and processing circuitry to execute the machine-readable instructions to:
obtain a certificate issued by a certificate authority, the certificate being configured to enable authentication of an identity of the apparatus to a verifier;
store the certificate in a trusted environment;
obtain a plurality of revocation data shards issued by the certificate authority, each revocation data shard covering a respective certificate issuance time range and comprising identifiers of revoked certificates issued within that time range;
select a revocation data shard of the plurality of revocation data shards based on an issuance time of the certificate; and
provide the certificate and the selected revocation data shard to the verifier for validation.

11. The apparatus of claim 10, wherein revocation data shard is selected based on the certificate's issuance time falling within the issuance time range covered by the selected revocation data shard.

12. The apparatus of claim 10, wherein the apparatus is configured to select the revocation data shard in an offline and/or air-gapped environment.

13. The apparatus of claim 10, wherein the plurality of revocation data shards is obtained before requesting the issuance of the certificate from the certificate authority.

14. The apparatus of claim 10, wherein the plurality of revocation data shards is obtained after requesting the issuance of the certificate from the certificate authority.

15. The apparatus of claim 10, wherein the processing circuitry is further to execute the machine-readable instructions to store the revocation data shards outside the trusted environment.

16. An apparatus comprising interface circuitry, machine-readable instructions, and processing circuitry to execute the machine-readable instructions to:
obtain a certificate issued by a certificate authority, the certificate authority being configured to enable authentication of an identity of a requester to the apparatus;
obtain a revocation data shard,
wherein the revocation data shard covers a certificate issuance time range and comprises identifiers of previously issued certificates that were issued by the certificate authority within that time range and have been revoked;
verify the validity of the certificate based on the issuance time of the certificate and the certificate issuance time range of the revocation data shard.

17. The apparatus of claim 16, wherein verifying the validity of the certificate comprises checking if the certificate's issuance time falls within the certificate issuance time range of the revocation data shard; and
rejecting the certificate if the issuance time does not fall within the certificate issuance time range of the revocation data shard.

18. The apparatus of claim 16, wherein verifying the validity of the certificate comprises checking if the certificate is listed as revoked in the revocation data shard; and
rejecting the certificate if it is listed.

19. The apparatus of claim 16, wherein verifying the validity of the certificate comprises validating the integrity of the revocation data shard based on a digital signature of the certificate authority.

20. The apparatus of claim 16, wherein the processing circuitry is further to execute the machine-readable instructions to:
store a revocation data identifier associated with a most recently accepted revocation data shard; and
reject a subsequently obtained revocation data shard having a revocation data identifier indicating an earlier issuance than the stored revocation data identifier.
